(19) United States
(12) Patent Application Publication
(10) Pub. No.: US 2024/0106966 A1
(43) Pub. Date: Mar. 28, 2024

(54) IMAGE FORMING APPARATUS, CONTROL METHOD OF IMAGE FORMING APPARATUS, AND STORAGE MEDIUM

(71) Applicant: CANON KABUSHIKI KAISHA, Tokyo (JP)

(72) Inventors: NAOYA TAKESUE, Tokyo (JP); FUMITAKA GOTO, Tokyo (JP)

(21) Appl. No.: 18/472,905

(22) Filed: Sep. 22, 2023

(30) Foreign Application Priority Data
Sep. 28, 2022 (JP) 2022-154801
Aug. 25, 2023 (JP) 2023-137187

(51) Int. Cl. G06K 15/02; G06K 15/00; G06K 15/10

(52) U.S. Cl. CPC G06K 15/188; G06K 15/005; G06K 15/027; G06K 15/102

(57) ABSTRACT

There is a possibility that the accuracy of color adjustment decreases due to high-frequency density unevenness on a test chart that is used in a case where sensor reading characteristics are obtained. The present disclosure solves this by correction processing (generating a correction table for sensor shading correction processing) of a reading sensor configuring a scan unit after removing high-frequency density unevenness in advance by performing color adjustment processing (head shading correction processing).

### BACKGROUND

### Field

The present disclosure relates to a color adjustment technique of a printer.

### Description of the Related Art

As an image forming apparatus for forming an arbitrary image on a sheet surface, an ink jet (IJ) printer is used widely, which forms an image by ejecting ink droplets from a plurality of nozzles. It is difficult to completely prevent the ink landing position and the ejection amount from deviating from the target position and ejection amount in all the nozzles arranged side by side in the print head and there is a case where belt-shaped or streak-shaped density unevenness (banding) appears on a printed material. Consequently, color adjustment (called “head shading correction”) to correct printing-target image data is performed in accordance with the printing characteristics of each nozzle (or each module), such as the shift of the ink ejection amount and the landing position, so that the density unevenness does not occur. In the head shading correction, the printing characteristics of the print head are obtained by scanning a test chart, but in a case where there are variations of the sensor reading characteristics, the sensor reading characteristics are taken in as the printing characteristics. In this case, on the contrary, the head shading correction causes the density unevenness to occur. Consequently, prior to the scan of a test chart, calibration of illumination and a sensor is performed generally with reference to a white reflection standard provided internally or externally. However, resulting from the angle dependence of the sensor and illumination, the sheet surface characteristics and the like, particularly, in a case where the spectral characteristics, such as a chromatic color, are different from those of the white reflection standard, there is a possibility that variations of the sensor reading characteristics remain. In this regard, Japanese Patent Laid-Open No. 2019-220828 has described a technique to suppress density unevenness resulting from the sensor reading characteristics by correcting the scanned data of a plurality of patch images of a plurality of tones based on colorimetric data of a uniform patch image of each color of CMYK.

With the method of Japanese Patent Laid-Open No. 2019-220828 described above, both the scanned data and the colorimetric data are utilized, but normally, the color space and the resolution are different between them because of the difference of the obtaining device. As a result of that, there is a possibility that the accuracy of color adjustment decreases due to high-frequency density unevenness on a test chart that is used in a case where the sensor reading characteristics are obtained.

### SUMMARY

The image forming apparatus according to the present disclosure includes: a printing unit configured to perform print processing based on image data; an image processing unit configured to perform color adjustment processing for the image data by using color adjustment information in accordance with characteristics of the printing unit; a first generation unit configured to generate the color adjustment information based on scanned data obtained by reading a first chart output from the printing unit by a scan unit; and a second generation unit configured to generate scan correction information in accordance with reading characteristics of the scan unit based on colorimetric data obtained by measuring a second chart output from the printing unit by a colorimetry unit, wherein the image processing unit performs the color adjustment processing for image data of the second chart before the printing unit prints and outputs the second chart, which is a target of the measurement, in a case where the second generation unit generates the scan correction information.

Further features of the present disclosure will become apparent from the following description of exemplary embodiments with reference to the attached drawings.

### BRIEF DESCRIPTION OF THE DRAWINGS

FIG. 1 is a diagram showing a hardware configuration of an image forming apparatus;

FIG. 2A is a diagram showing a configuration example of the periphery of a printing unit, FIG. 2B is an enlarged diagram of a print head, FIG. 2C is an enlarged diagram of a head module, and FIG. 2D is an enlarged diagram of a chip module;

FIG. 3 is a diagram showing an internal configuration of an image processing unit;

FIG. 4 is a diagram showing one example of a color adjustment table;

FIG. 5 is a diagram showing one example of a scan correction table;

FIG. 6 is a flowchart showing a flow of processing in an image processing unit;

FIG. 7 is a flowchart showing a flow of color adjustment table generation processing;

FIG. 8 is a diagram showing one example of an HS chart;

FIG. 9 is a diagram explaining position adjustment processing;

FIG. 10A is a diagram showing one example of a measured curve and FIG. 10B is a diagram explaining a calculation process of a correction amount;

FIG. 11 is a flowchart showing a flow of scan correction table generation processing;

FIG. 12 is a diagram showing one example of an SS chart;

FIG. 13A and FIG. 13B are each a diagram explaining the generation of a line profile based on scanned data;

FIG. 14A to FIG. 14D are each a diagram explaining the generation of a line profile based on colorimetric data;

FIG. 15A and FIG. 15B are each an explanatory diagram of SS corrected value derivation processing;

FIG. 16A to FIG. 16D are each a diagram showing an example of a sensor value that varies depending on a pixel position;

FIG. 17A to FIG. 17C are each a conceptual diagram showing a relationship between a streak and an opening position;

FIG. 18 is a diagram showing a configuration example of the periphery of a printing unit;

FIG. 19A and FIG. 19B are each a diagram showing a variation of colorimetry;

FIG. 20 is a diagram showing one example of a user interface screen;

FIG. 21 is a diagram showing an internal configuration of an image processing unit;

FIG. 22 is a flowchart showing a flow of color adjustment table generation processing;

FIG. 23 is a flowchart showing a flow of scan correction table generation processing;

FIG. 24 is a flowchart showing a flow of paper white calibration processing;

FIG. 25 is a diagram showing one example of a scan correction table;

FIG. 26A is a cross-sectional diagram of a scan unit at the time of reading a sheet and FIG. 26B is a cross-sectional diagram of the scan unit at the time of reading a white reflection standard;

FIG. 27 is a diagram showing an internal configuration of an image processing unit;

FIG. 28A is a flowchart showing a flow of color adjustment table generation processing and FIG. 28B is a flowchart showing a flow of scan correction table generation processing;

FIG. 29 is a flowchart showing a flow of paper white calibration processing of each sensor position;

FIG. 30 is a diagram showing one example of a scan correction table; and

FIG. 31A is a diagram schematically showing a line profile at the time of the generation of a table, FIG. 31B is a diagram schematically showing results of performing paper white calibration processing of each sensor position, and FIG. 31C is a diagram showing one example of a line profile that is obtained at the time of the application of a table.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### <Hardware Configuration of Image Forming Apparatus>

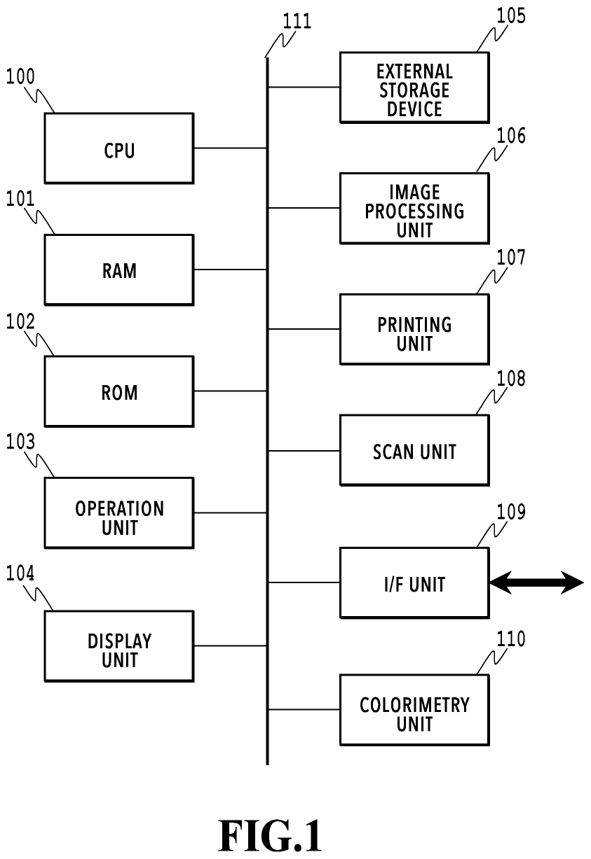

FIG. 1 is a diagram showing a hardware configuration of an ink jet printer as an image forming apparatus according to the present embodiment. The image forming apparatus in the present embodiment comprises a CPU 100, a RAM 101, a ROM 102, an operation unit 103, a display unit 104, an external storage device 105, an image processing unit 106, a printing unit 107, a scan unit 108, an I/F (interface) unit 109, a colorimetry unit 110, and a bus 111. The CPU 100 controls the operation of the entire image forming apparatus by loading input data and computer programs stored in the ROM 102 and the external storage device, to be described later, onto the RAM 101 and executing them. For example, the CPU 100 generates image data in the bitmap format of each page by interpreting PDL data included in an input print job. Here, a case where the CPU 100 controls the entire image forming apparatus is explained as one example thereof, but it may also be possible to control the entire image forming apparatus by a plurality of pieces of hardware sharing processing. The RAM 101 temporarily stores computer programs and data read from the external storage device 105 and data received from the outside via the I/F unit 109. Further, the RAM 101 is used as a storage area at the time of the CPU 100 performing arithmetic processing and as a storage area at the time of the image processing unit 106 performing image processing. The ROM 102 stores setting parameters used to set each unit in the image forming apparatus, boot programs and the like. The operation unit 103 is an input device, such as a keyboard and a mouse, and receives operations (instructions) of an operator. Due to this, it is possible for the operator to input various instructions to the CPU 100. The display unit 104 is a display device, such as a CRT and a liquid crystal screen, and displays processing results by the CPU 100 in images, characters and the like. In a case where the display unit 104 is a touch panel capable of detecting a touch operation, it may also be possible for the display unit 104 to function as part of the operation unit 103. The external storage device 105 is a large-capacity storage device, typically such as a hard disk drive. In the external storage device 105, computer programs, data and the like used to cause the OS and the CPU 100 to perform various types of processing are stored. Further, in the external storage device 105, temporary data (for example, image data that is input and output, threshold value matrices used by the image processing unit 106 and the like) that is generated by the processing of each unit is also stored. The computer programs and data stored in the external storage device 105 are read appropriately in accordance with the control by the CPU 100 and loaded onto the RAM 101 to be taken as the target of the processing by the CPU 100. The image processing unit 106 is implemented as a processor or a dedicated image processing circuit capable of executing computer programs and performs various types of image processing for converting image data that is input as a printing target into image data that can be output by the printing unit 107. It may also be possible to employ a configuration in which the CPU 100 performs various types of image processing as the image processing unit 106, in place of preparing a dedicated processor as the image processing unit 106. The printing unit 107 forms an image by using ink as a color material on a sheet as a printing medium based on image data received directly from the image processing unit 106 or via the RAM 101 or the external storage device 105. Details of the printing unit 107 will be described later. The scan unit 108 is an image sensor (line sensor or area sensor) for optically reading an image formed on a sheet by the printing unit 107. Details of the scan unit 108 will be described later. The I/F unit 109 functions as an interface for connecting the image forming apparatus and an external device. Further, the I/F unit 109 also functions as an interface for performing transmission and reception of data with a communication device by using infrared communication, wireless LAN (Local Area Network) or the like, for connecting to the internet, and so on. Due to this, the I/F unit 109 receives printing-target image data from, for example, an external PC (not shown schematically). The colorimetry unit 110 is a colorimeter for measuring the color of an image formed on a sheet by the printing unit 107. Details of the colorimetry unit 110 will be described later. Each of the above-described units is connected to the bus 111 and capable of performing transmission and reception of data via the bus 111.

The hardware configuration shown in FIG. 1 is one example and it may also be possible for the image forming apparatus to have a hardware configuration whose contents are different from those shown in FIG. 1. For example, a configuration may be accepted in which the printing unit 107 is connected via the I/F unit 109. Further, it may also be possible to employ a configuration in which colorimetric information is obtained from an external colorimeter via the I/F unit 109, in place of the configuration in which the colorimetry unit 110 is comprised as part of the image forming apparatus.

### <Details of Printing Unit>

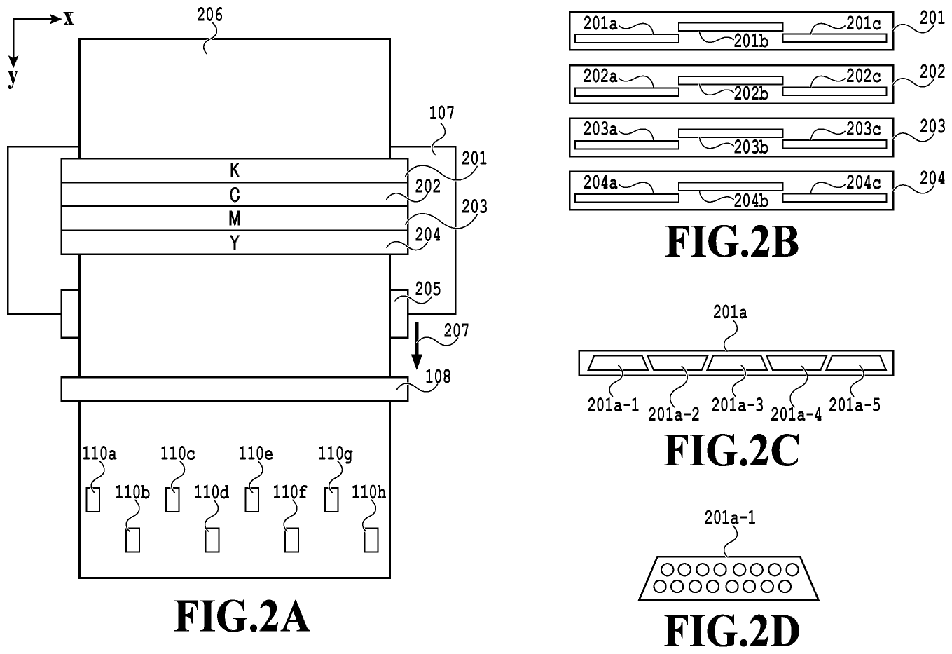

The printing unit 107 comprises, as shown in FIG. 2A, print heads 201 to 204 corresponding to black (K), cyan (C), magenta (M), and yellow (Y), respectively. Each of the print heads 201 to 204 is a so-called full-line type and in which a plurality of nozzles for ejecting ink is arrayed along a predetermined direction in a range corresponding to the full width of a sheet 206. Each of the print heads 201 to 204 has, as shown in FIG. 2B, a configuration in which a plurality of head modules is arranged in such a manner that one is arranged on the lower side, the next is on the upper side, the next is on the lower side, and so on, in the sheet conveyance direction. FIG. 2C is an enlarged diagram of a head module 201a and shows that the head module 201a further includes a plurality of chip modules 201a-1 to 201a-5. Each chip module is connected to each substrate independent of one another. FIG. 2D is an enlarged diagram of the chip module 201a-1 and in which 16 nozzles exist. In the present embodiment, explanation is given on the assumption that the resolution of the arrangement of nozzles in the print heads 201 to 204 of each of CMYK is 1,200 dpi.

The sheet 206 as a printing medium is conveyed in one direction indicated by an arrow 207 in FIG. 2A by a conveyance roller 205 (and another roller, not shown schematically) rotating by the driving force of a motor (not shown schematically). Then, while the sheet 206 is being conveyed, an image of one raster corresponding to the nozzle row of each of the print heads is formed by ink being ejected from a plurality of nozzles of each of the print heads 201 to 204 in accordance with print image data. By repeating the ink ejection operation from each of the print heads 201 to 204 for the sheet 206 that is conveyed as described above, for example, it is possible to form an image corresponding to one page on the sheet.

### <Details of Scan Unit and Colorimetry Unit>

The scan unit 108 is installed, as shown in FIG. 2A, as a line sensor that covers the full width of the sheet 206 on the downstream side of the print heads 201 to 204. After an image is formed on the sheet 206 by the print heads 201 to 204, the sheet 206 is conveyed to the scan unit 208. Then, on the further downstream side of the scan unit 108, the colorimetry unit 110 is installed and in FIG. 2A, eight colorimeters 110a to 110h configuring the colorimetry unit 110 are shown. Both the scan unit 108 and the colorimetry unit 110 are required only to be on the downstream side of the printing unit 107 and for example, it may also be possible to employ a configuration in which the colorimetry unit 110 is installed on the upstream side of the scan unit 108.

The scan unit 108 optically reads the sheet 206 that is conveyed and stores in the external storage device 105 as read image data (scanned data). Here, the scanned data is information on a two-dimensional image in which each pixel has RGB values or a luminance value and whose resolution is, for example, 600 dpi both in the x-direction and in the y-direction shown schematically in FIG. 2A. The resolution in the x-direction and the resolution in the y-direction may be different.

Each of the colorimeters 110a to 110h configuring the colorimetry unit 110 measures the color at a predetermined position in the x-direction of the sheet 206 that is conveyed and stores in the external storage device 105 as spectral reflectance data. Alternatively, each of the colorimeters 110a to 110h stores the color value in a device-independent color space, which is calculated from spectral reflectance data, in the external storage device 105. Specifically, each of the colorimeters 110a to 110h stores spectral reflectance data at intervals of 10 nm from 380 to 780 nm, which is a visible light range, and the spectral reflectance data after converting them into data in a color space, such as CIE XYZ, CIE Lab, sRGB, or AdobeRGB. The interval of colorimetry by the colorimetry unit 110 is generally longer than the interval of reading (interval of scanning) of the scan unit 108 and for example, the interval of colorimetry in the y-direction is five times/inch. The spectral reflectance data, which is colorimetry results, is obtained as the reflectance averaged within an opening shape of each of the colorimeters 110a to 110h, for example, within a circle with a diameter p of 3.5 mm. In a case where the conveyance speed is high for the interval of colorimetry and it is not possible to stably perform colorimetry, it may also be possible to reduce the conveyance speed only during the time of colorimetry. Alternatively, it may also be possible to perform colorimetry by temporarily stopping conveyance. Further, it may also be possible to perform colorimetry by moving the sheet 206 to a conveyance path different from the conveyance path for printing and scanning in order to avoid the control of the conveyance speed from becoming complicated.

### <Details of Image Processing Unit>

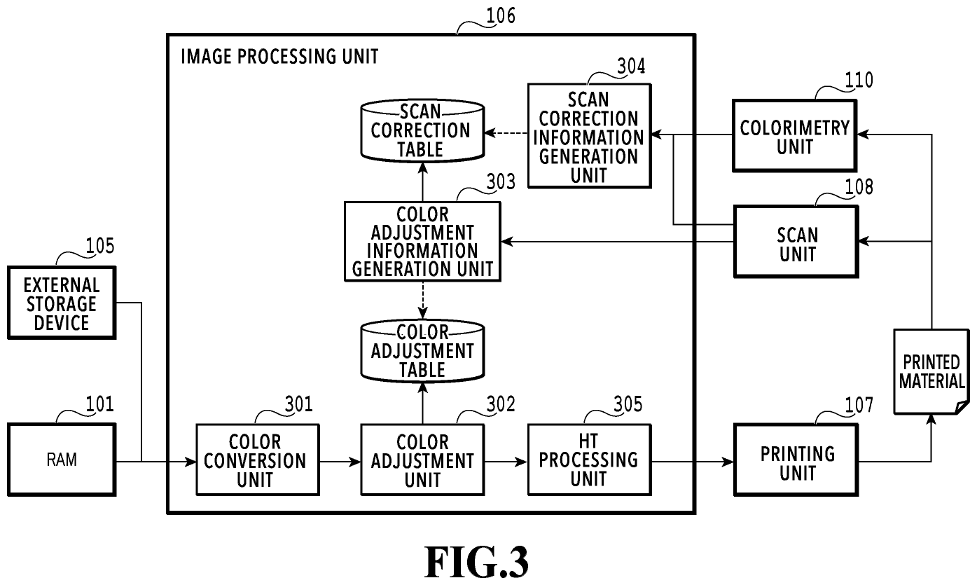

FIG. 3 is a diagram showing the internal configuration of the image processing unit 106 according to the present embodiment. In the following, with reference to FIG. 3, the function of the image processing unit 106 is explained in detail.

The image processing unit 106 has a color conversion unit 301, a color adjustment unit 302, and a halftone processing unit (in the following, described as “HT processing unit”) 305. Further, the image processing unit 106 has a color adjustment information generation unit 303 and a scan correction information generation unit 304.

The color conversion unit 301 converts input image data into image data in accordance with the ink colors that are used in the printing unit 107. For this conversion, it is possible to use a publicly known method, for example, such as matrix arithmetic processing and processing using a three-dimensional LUT (lookup table). The input image data has 8-bit coordinate values (R, G, B) in a color space, such as sRGB, which are, for example, representation colors of a monitor, and the color-converted image data has an 8-bit color signal value of each of CMYK in accordance with the printing unit 107. That is, by the color conversion processing, RGB data is converted into CMYK data. The CMYK data represents an amount (ejection amount) of ink to be used of each ink that is ejected onto the sheet surface in order for the printing unit 107 to represent an image. The input image data is not limited to RGB data and may be CMYK data. Even in a case where CMYK data is input from the beginning, it is preferable to perform conversion processing using a four-dimensional LUT that converts input CMYK data into C‘M’Y‘K’ data for limiting the total amount of ink and for color management.

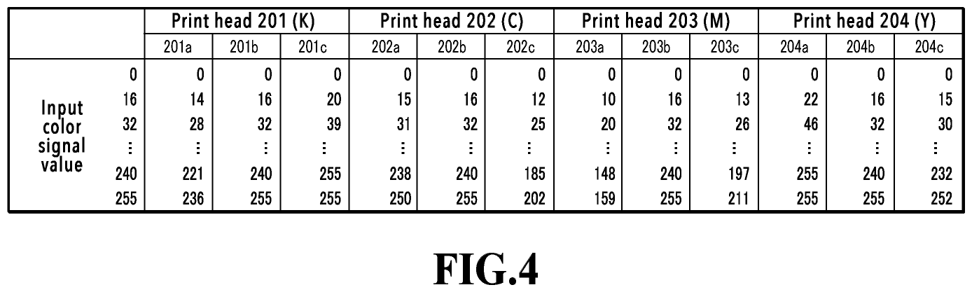

The color adjustment unit 302 performs color adjustment processing (head shading correction processing) that takes into consideration the ink ejection unevenness of each of the print heads 201 to 204 for the color-converted CMYK data by referring to a color adjustment table generated by the color adjustment information generation unit 303. FIG. 4 shows one example of a color adjustment table (head shading correction table). In the color adjustment table shown in FIG. 4, the adjusted color signal value (output color signal value) corresponding to each input color signal value (0, 16, 32, . . . , 240, 255) is stored for each of the print heads 201 to 204. For example, in the data corresponding to the ink color K of the CMYK data, in a case where the input color signal value of the pixel corresponding to the head module 201a is “32”, the color signal value of the pixel, which has been adjusted by the color adjustment processing, is “28”. It is also possible to perform the color adjustment processing for each head module, each chip module, or each nozzle in place of performing for each print head. Further, it is also possible to perform the color adjustment processing for each nozzle block obtained by dividing nozzles into blocks each including a predetermined number of nozzles, for example, for each nozzle block including eight nozzles. In a case where the color adjustment processing is performed for each nozzle, the color adjustment information generation unit 303 generates a color adjustment table having the number of columns equal to the number of nozzles. For an input color signal value that is not predefined in the color adjustment table shown in FIG. 4, the input color signal values in the vicinity of the input color signal value that is not predefined are identified from the predefined input color signal values and the output color signal value for the input color signal value that is not predefined is calculated from those predefined input color signal values by using interpolation processing. It is of course possible to store output color signal values for all the input color signal values in place of using interpolation processing. It is also possible to perform the color adjustment processing by using function transformation or matrix transformation in place of a table method.

The color adjustment information generation unit 303 generates the above-described color adjustment table by receiving scanned data of a dedicated chart (in the following, called “HS chart”) for generating a color adjustment table (head shading correction table) from the can unit 108.

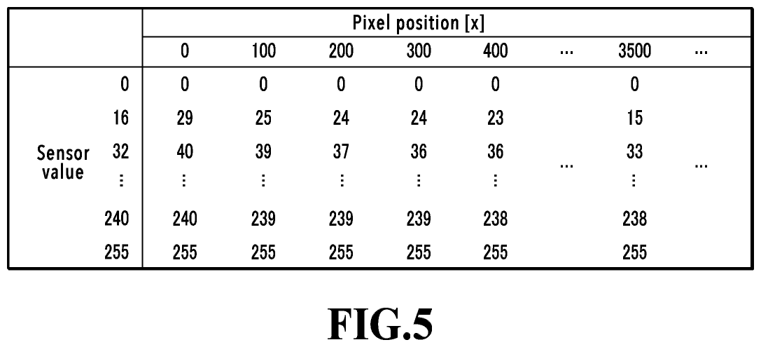

The scan correction information generation unit 304 generates a table (in the following, called “scan correction table”) that is referred to in sensor shading correction processing. For this generation, the scanned data of the HS chart, which is received from the scan unit 108, and colorimetric data of a dedicated chart (in the following, called “SS chart”) for generating the scan correction table, which is received from the colorimetry unit 110, are used. FIG. 5 shows one example of the scan correction table. In the SS correction table shown in FIG. 5, the corrected sensor value corresponding to each sensor value (0, 16, 32, . . . , 240, 255) included in the scan data is stored in association with the pixel position (0, 100, 200, 300, 400, . . . , 3500, . . . ) in the x-direction. For example, in a case where the sensor value at the pixel position “100” is “32”, the sensor value (SS corrected value) for which the sensor shading correction processing has been performed is “39”. For a sensor value that is not predefined in the scan correction table shown in FIG. 5, the SS corrected value is calculated by interpolation processing using the SS corrected values corresponding to the adjacent sensor values among the predefined sensor values. Similarly, for the sensor value at a pixel position that does not exist in the scan correction table, the SS corrected value is also calculated by interpolation processing using the SS corrected values at the adjacent pixel positions. It is of course possible to store the SS corrected values corresponding to all the sensor values and all the pixel positions without using interpolation processing. As in the case of the color adjustment table, in the scan correction table, it is also possible to perform the sensor shading correction processing by function transformation or matrix transformation in place of a table method.

The HT processing unit 305 generates data of a halftone image (in the following, described as “HT image data”) represented by halftone dots that the printing unit 107 can represent by performing halftone processing for each color plane for the color-adjusted CMYK data. By this halftone processing, binary HT image data in which each pixel has a value of “0” or “1” is generated for each color plane of CMYK. For the halftone processing, it may be possible to apply a publicly known method, such as the dither method and the error diffusion method.

### <Processing Flow of Image Processing Unit>

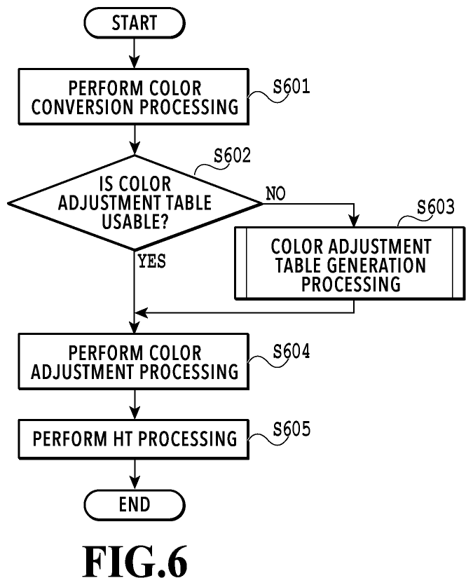

Next, each piece of processing that is performed by the image processing unit 106 is explained along the flowchart shown in FIG. 6. In a case where a user inputs a print job to the image forming apparatus through the operation unit 103, printing-target image data (bitmap image of each page) and printing conditions are loaded onto the RAM 101. Then, the series of processing shown in the flowchart in FIG. 6 is started and performed for each page. Here, the print job is information on instructions for print processing and includes, in addition to PDL data predefining contents to be printed for each page, information on the number of copies and the printing sheet, information on the print mode, and printing conditions, such as single-sided printing/double-sided printing, Nin1 and the like. In the information on the sheet, the maker name, the model number and the like are included, in addition to the sheet type, such as plain paper and glossy paper, and the sheet size, such as A4 and A3. Further, in the information on the print mode, the designation of a high coloring mode in which the conveyance speed is reduced and the amount of ink is increased and an ink-saving mode in which the conveyance speed is increased and the amount of ink is reduced. In the following explanation, a symbol “S” means a step.

At S601, the color conversion unit 301 converts RGB data, which is input image data, into CMYK data by performing color conversion processing.

At next S602, the color adjustment unit 302 determines whether or not it is possible to use a color adjustment table satisfying the printing conditions designated in the print job. Specifically, in a case where there exists a color adjustment table in the external storage device 105 or the like, which corresponds to the maker name, the model number, and the sheet type of the designated sheet, or the contents of the designated print mode, the color adjustment unit 302 determines that it is possible to use a color adjustment table satisfying the printing conditions. On the other hand, in a case where a color adjustment table whose maker name, the model number and the like match the maker name, the model number and the like of the designated sheet does not exist in the external storage device 105 or the like, the color adjustment unit 302 determines that there is not a color adjustment table that can be used. The reason is that the correction amount for correcting the nozzle characteristics is supposed to be inappropriate for the designated sheet. Consequently, in a case where there is no concern that the correction amount for correcting the nozzle characteristics is inappropriate, it may also be possible to determine that the color adjustment table can be used even though part of the printing conditions are not satisfied. For example, the sheet basis weight and the sheet size do not affect the correction amount so much, and therefore, it is possible to determine that the color adjustment table satisfying the printing conditions is in the usable state even though the basis weight and the size are different from those of the sheet at the time of the generation of the stored color adjustment table. In a case where a new type of sheet is set, whose sheet quality is different from that of the sheet at the time of the generation of the stored color adjustment table, it is preferable to derive the correction amount for head shading correction by using the newly set sheet. Further, it may also be possible to take into consideration the elapsed time from the generation and whether or not the head cleaning processing has been performed. That is, in a case where the color adjustment table in accordance with the designated sheet is already generated and stored and a predetermined time has elapsed from the generation, it may also be possible to determine that there is not a color adjustment table that can be used. Alternatively, in a case where the head cleaning processing has been performed after the generation, it may also be possible to determine that there is not a color adjustment table that can be used. Further, it may also be possible for a user to determine whether or not the table can be used and store flag information indicating the results of the determination and perform determination based on the flag information. In that case, it is sufficient for a user to set a flag through the operation unit 103 at timing at which a new sheet is set or the head is replaced with another Alternatively, it may also be possible to set a flag by checking the results of test printing by visual inspection. In a case where the determination results indicate that a color adjustment table that can be used exists in the external storage device 105 or the like, the processing advances to S604. On the other hand, in a case where it is determined that there is not a color adjustment table that can be used, the processing advances to S603.

At S603, the color adjustment information generation unit 303 generates a color adjustment table satisfying the printing conditions designated in the print job. Details of the color adjustment table generation processing will be described later.

At S604, the color adjustment unit 302 performs color adjustment processing for the CMYK data obtained by the color conversion at S601 by using the appropriate color adjustment table that can be used. Here, it is assumed that the density of an image that is formed by the head module 201a in a case where the input color signal value is “32” is relatively high compared to the target density or the density that is formed by another print head. In this case, by changing the pixel value of the input image data to a smaller value (for example, “28”), it is possible to reduce the probability that dots are formed by the head module 201a in a case where the input color signal value is “32”. By the processing such as this, it is possible to reduce the difference from the target density and another print head. In the present embodiment, the color adjustment table as shown in FIG. 4 described previously is generated and stored in advance for each of a variety of types of sheet and for each print mode. Then, in a case where there is not a color adjustment table in accordance with the sheet and the print mode designated in the print job, a color adjustment table is generated newly. In this manner, the change in density that occurs in each print head and each print nozzle is suppressed.

At S605, the HT processing unit 305 performs halftone processing for the color-adjusted CMYK data. The generated HT image data is sent to the printing unit 107 and in the printing unit 107, print processing is performed based on the HT image data.

The above is the contents of the processing in the image processing unit 106. The processing such as this is performed each time a print job is input and it is possible to print the designated number of sheets of the image designated by a user. In the determination at S602, in a case where the model number and the maker name of the sheet are different, but the sheet type is the same, it may also be possible to determine that the color adjustment table can be used. For example, such a case is where even though the coated paper is designated, the coated paper of the same maker has run out, and therefore, the coated paper of another maker is replenished. In the case such as this, on a condition that it is known empirically that there is no problem, it may also be possible to enable the application of the color adjustment table used before the replenishment as it is.

### <Color Adjustment Table Generation Processing>

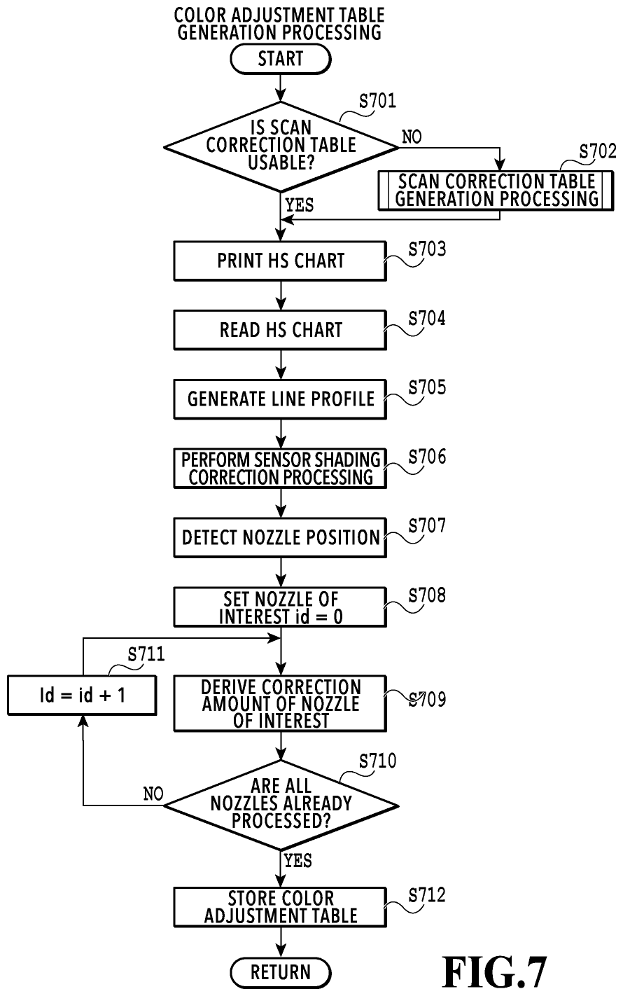

Following the above, with reference to the flowchart in FIG. 7, the color adjustment table generation processing at S603 described above is explained in detail. The following explanation is given by taking a case as an example where a color adjustment table is generated for each nozzle.

First, at S701, whether or not it is possible to use a scan correction table satisfying the printing conditions designated in the print job is determined. The reference at the time of this determination may be the same as the reference shown at S602 in the flowchart in FIG. 6 described previously. The reason is that as in the case of the color adjustment table, for the scan correction table also, the correction amount for correcting the sensor reading characteristics may be different depending on the sheet to be used and the print mode. Consequently, in a case where anew type of sheet is used, it is preferable to derive a correction amount for sensor shading correction with the new type of sheet. However, the spectral characteristics are hardly affected by the sheet basis weight and the sheet size, and therefore, it may also be possible to accept these differences and perform determination by using a bit less strict reference. It may be possible to take into consideration the elapsed time from the generation and this is the same as at S602 described previously. That is, only in the case where there is a scan correction table whose elapsed time from its generation is within a predetermined time, it may be possible to determine that there is a scan correction table that can be used. The reason is that there is a case where the color of the filter inside the sensor changes or the spectral characteristics of the illumination change as time elapses and there is a possibility that the scan correction table is no longer suitable to the sensor having changed such as this.

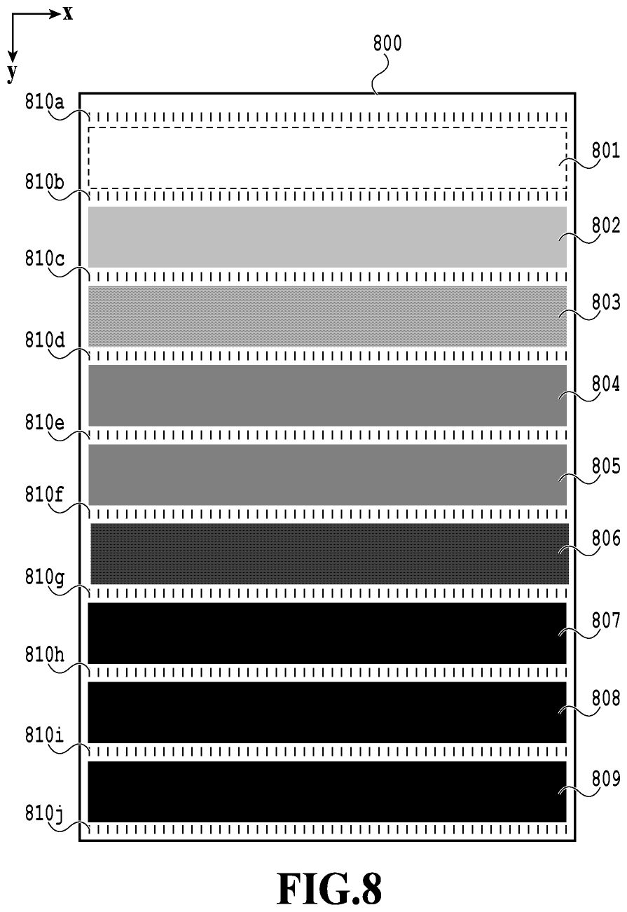

At S703, the HS chart is printed and output. Specifically, the image data of the HS chart stored in the external storage device 105 or the ROM 102 is read, the HT processing unit 305 performs halftone processing, and the printing unit 107 performs print processing by using the generated HT image data. FIG. 8 shows one example of the HS chart. It is preferable for a pattern area for matching the nozzle position with the reading position to exist in the HS chart, in addition to the measurement area for obtaining the density characteristics of each nozzle. In a case of an HS chart 800 in FIG. 8, nine measurement areas 801 to 809 exist, whose tones are different from one another and each of which has a uniform color signal value. In addition, position adjustment patterns 810 for matching the nozzle position with the reading position are arranged as position adjustment patterns 810a to 810j so as to sandwich each of the measurement areas 801 to 809. The position adjustment pattern 810 includes a plurality of lines in the y-direction, which are formed at predetermined intervals.

At S704, the scanned data of the printed and output HS chart is obtained. Specifically, the HS chart for which the print processing has been performed by the printing unit 107 is read by the scan unit 108 and the scanned data of the HS chart is generated.

At S705, based on the scanned data of the HS chart, which is obtained at S704, a line profile is generated. Specifically, the image area corresponding to the measurement area of the HS chart is identified from the scanned data and one-dimensional data (line profile) is found, which is obtained by averaging the sensor values in the conveyance direction (y-direction). The line profile is one obtained by averaging each read value at the different y-position at the same x-position in each measurement area. In a case where the HS chart 800 shown in FIG. 8 described previously is used, nine line profiles corresponding to each of the measurement areas 801 to 809 are obtained.

At S706, for each line profile obtained at S705, sensor shading correction processing based on the pixel position in the x-direction is performed by using a scan correction table that can be used. Here, a case is considered where the sensor value at the pixel position x=50 of the line profile corresponding to the measurement area 808 of the HS chart 800 shown in FIG. 8 is “24” and the sensor shading correction processing is performed by using the scan correction table shown in FIG. 5. In this case, first, the SS corrected values for the sensor value “24” at the pixel positions x=0, 100 are found by the interpolation calculation. Specifically, for the pixel position x=0, from the SS corrected values “29” and “40” corresponding to the sensor values “16” and “32”, 29+(40−29)×(24−16)÷(32−16)=34.5 is obtained as the SS corrected value. Similarly, for the pixel position x=100, 32.0 is obtained as the SS corrected value. Then, from the two calculated SS corrected values “34.5” and “32.0”, 32.0+(34.5−32.0)×(100−50)÷(100−0)=33.25 is obtained as the SS corrected value for the pixel position x=50. As described above, by finding the SS corrected value at each pixel position in the x-direction based on the scan correction table for each line profile, the line profile for which the sensor shading correction processing has been performed is obtained.

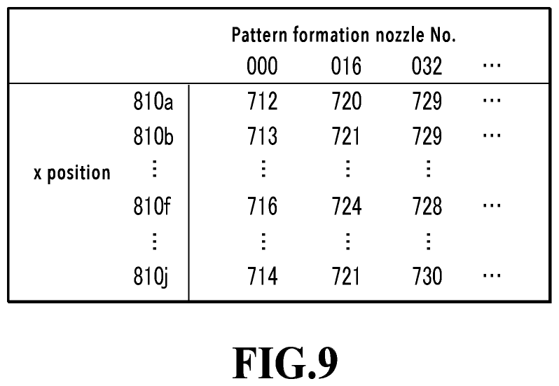

At S707, based on the scanned data of the HS chart, which is obtained at S704, the identification number (nozzle number) of the nozzle having passed through each pixel position in the x-direction is identified for each measurement area of the HS chart. Specifically, each image area within the scanned data, which corresponds to each position adjustment pattern 810 of the HS chart 800, is identified and the pixel position in the x-direction on the image in each line profile and the nozzle number are associated with each other. Specific explanation is given by using FIG. 9. The table shown in FIG. 9 shows the center pixel position in the x-direction in the scanned data of each line configuring the position adjustment patterns 810a to 810j. It is assumed that the resolution (≈ nozzle interval) in the x-direction of the printing unit 107 is 1,200 dpi. It is also assumed that the interval between nozzles forming the line is 16 nozzles. Then, it is assumed that the resolution (≈ pixel interval) in the x-direction of the scan unit 108 is 600 dpi. Here, a pixel position X in the x-direction, which corresponds to the nozzle number “016”, in the measurement area 801 is considered. First, attention is focused on the pixel position X of the position adjustment patterns 810a and 810b located over and under the measurement area 801. From the table in FIG. 9, it is known that the coordinate value of the pixel position X for the nozzle number “016” is 720 and 721, respectively. Consequently, the pixel position X corresponding to the nozzle number “016” in the measurement area 801 is their average value=720.5. As in the case of the color adjustment table, it is possible to calculate the pixel position X corresponding to the nozzle number of the nozzle not contributing to the formation of the position adjustment pattern by performing linear interpolation of the coordinate values of the pixel positions in the x-direction, which are obtained from the nozzle numbers of the adjacent nozzles contributing to the formation of the position adjustment pattern. In this manner, for each line profile, the pixel positions in the x-direction are identified, which correspond to all the nozzle numbers.

At S708, the nozzle number of the nozzle of interest (nozzle of interest id) among all the nozzles arrayed in the x-direction is initialized. Specifically, the nozzle of interest id=0 is set.

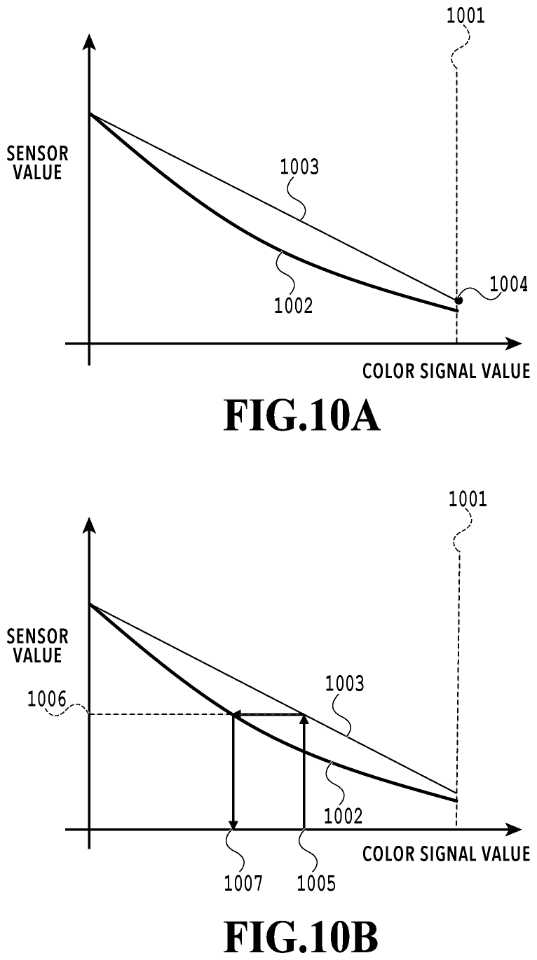

At S709, the correction amount for the current nozzle of interest id is derived and the adjusted color signal value for the nozzle of interest is determined. Specific explanation is given by using the drawings. First, for the generation of the color adjustment table, a measured curve corresponding to the nozzle of interest is calculated. Here, the measured curve is a curve indicating a relationship between the color signal value of the target measurement area and the sensor value at the pixel position corresponding to the nozzle of interest on each line profile. FIG. 10A shows an example of the measured curve. The horizontal axis in FIG. 10A represents the color signal value of an image that is formed on a sheet by the printing unit 107 and the vertical axis represents the sensor value obtained by the scan unit 108 scanning the sheet. A broken line 1001 in FIG. 10A indicates the upper limit value of the horizontal axis and in a case where the input color signal value is an 8-bit value, the upper limit value is “255”. A curve 1002 in FIG. 10A is a measured curve obtained by combining the color signal value of the measurement area included in the HT chart and the sensor value corresponding to each tone, and further combining the interpolation calculation. As the interpolation method, it may be possible to use a publicly known method, such as the piecewise linear interpolation and the spline curve. The measured curve 1002 represents the density characteristics of the nozzle corresponding to the pixel position in the x-direction of the scanned data and for example, for he nozzle whose ejection amount is small, the curve shifts in the upward direction (toward the brighter direction). A straight line 1003 in FIG. 10A represents the ejection characteristics (target ejection characteristics) common to all the nozzles, which is the correction target of each nozzle. It may be possible to set the target ejection characteristics by, for example, finding each value that is linear to a sensor value 1004 corresponding to the maximum color signal value determined in advance. Alternatively, it may also be possible to take the head module, the chip module, or the nozzle to be a reference and set the ejection characteristics of the reference module or nozzle as the target ejection characteristics. Alternatively, it may also be possible to set the ejection characteristics obtained by averaging the ejection characteristics of the head modules, the chip modules, or the nozzles in a predetermined range as the target ejection characteristics. FIG. 10B is a diagram explaining the calculation process of the correction amount. First, the nozzle of interest id and an input color signal value 1005 that is taken to be the target of the correction amount calculation are obtained. Next, a target color signal value 1006 corresponding to the obtained input color signal value 1005 is obtained from the target ejection characteristics 1003 of the nozzle of interest. Further, from the measured curve 1002 of the nozzle of interest, the tonal value corresponding to the target color signal value 1006 is obtained as an adjusted color signal value 1007. Then, the obtained adjusted color signal value 1007 and the input color signal value 1005 are associated with each other and stored in the color adjustment table being generated in association with the nozzle of interest. By performing the processing such as this with all the values of 0 to 255 being taken as the input color signal value 1005, it is possible to obtain a table corresponding to all the tonal values for the nozzle of interest. Alternatively, it may also be possible to generate a table corresponding to, for example, nine specific tonal values, by thinning the tonal values. In that case, it may be possible to find the value other than the specific tonal values from the nine specific tonal values by publicly known interpolation processing.

At S710, whether all the nozzles are already processed as the nozzle of interest is determined. In a case where the nozzle of interest id is larger than or equal to the number of nozzles comprised by the print heads 201 to 204, it is determined that all the nozzles are already processed as the nozzle of interest. In a case where there is an unprocessed nozzle, the processing advances to S711 and the nozzle of interest id is updated, and the processing returns to S709 and the same processing is repeated. On the other hand, in a case where it is determined that all the nozzles are already processed as the nozzle of interest, the processing advances to S712.

At S712, the color adjustment table obtained by the processing up to this point is stored in the external storage device 105. At this time, the color adjustment table is stored in association with information on the sheet, such as the maker name, the model number, and the sheet type of the used sheet, the printing conditions, such as the print mode, and the date of generation.

The above is the contents of the color adjustment table generation processing of each nozzle. By performing the processing such as this for each ink color (C, M, Y, K), the color adjustment table is completed. In the flowchart in FIG. 7, the sensor shading correction processing based on the pixel position in the x-direction is performed for the line profile (S706), but this is not limited. For example, it may also be possible to generate the line profile by performing the sensor shading correction processing for the scanned data of the HS chart read at S704 and detecting the nozzle position thereafter. However, in a case where the conveyance error in the x-direction in the printing unit 107 is an low-frequency error, it is preferable to perform the sensor shading correction processing for the line profile as shown in the flowchart in FIG. 7. For example, such a case is where the conveyance error in the x-direction is smaller than the reading resolution in the x-direction of the scan unit 108 or is estimated to be smaller than the printing resolution in the x-direction of the printing unit 107 in each of the measurement areas 801 to 809 in the HS chart 800 in FIG. 8. In the case such as this, it is recommended to perform the sensor shading correction processing for the line profile. In the case such as this, it is possible to reduce the processing time more by performing the sensor shading correction processing for the line profile than by performing the correction for each pixel of the scanned data of the HS chart. Further, it is also possible to reduce the influence of noise resulting from the sensor and the halftone processing by the averaging processing at the time of calculating the line profile. On the other hand, in a case where the conveyance error whose magnitude is one or more pixels occurs in the x-direction within each measurement area, the correspondence between the nozzle formed within the measurement areas 801 to 809 and the reading element is different depending on the y-position. Because of this, in the head shading correction processing, it is preferable to generate the line profile by performing averaging while sliding obliquely. On the other hand, it is preferable to perform the sensor shading correction processing based on the position of an imaging element. Consequently, in a case of a shift of one or more pixels, it is preferable to calculate the line profile by performing averaging processing based on the position adjustment pattern 810 after performing the sensor shading correction in accordance with the pixel position in the x-direction in the scanned data of the HS chart.

### <Scan Correction Table Generation Processing>

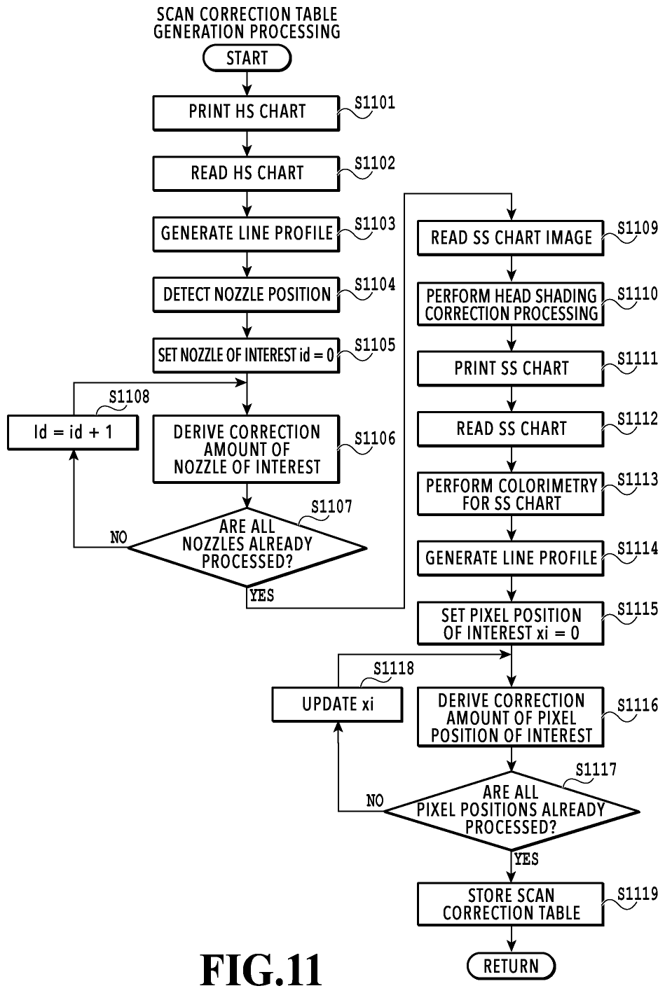

Next, with reference to the flowchart shown in FIG. 11, the scan correction table generation processing at S702 described above is explained in detail. In the method of the present disclosure, color adjustment processing for removing high-frequency density unevenness resulting from the printing unit 107, particularly from the print heads 201 to 204 is performed prior to the printing of the SS chart. In the following, explanation is given along the flow in FIG. 11. Each piece of processing at S1101 to S1108 corresponds to each piece of processing at S703 to S705 and S707 to S711 in the flowchart in FIG. 7 described previously. That is, of the color adjustment table generation processing described previously, each piece of processing except for the sensor shading correction processing (S706) for the line profile is performed. It may also be possible to remove only the density unevenness whose frequency is higher than or equal to a specific frequency, which results from the print head, from the SS chart by applying a high-pass filter at the time of the derivation of the correction amount of the nozzle of interest (S1106), at the time of the line profile generation (S1103) or the like. By doing so, it is possible to suppress low-frequency density unevenness resulting from the sensor from occurring in the SS chart. It is preferable to design the high-pass filter at this time so that the density is substantially uniform within the diameter of the opening as least of the colorimeters 110a to 110j, that is, the density unevenness whose frequency corresponds to the diameter of the opening of the colorimeter or less can be removed. For example, in a case where it is assumed that the opening diameter of the colorimeter is 3.5 mm and the resolution in the x-direction of the scan unit 108 is 600 dpi, the opening diameter on the scanned data corresponds to about 83 px. In this case, it is preferable to suppress the density unevenness corresponding to 83 px or less by the color adjustment processing prior to the sensor shading correction processing. That is, it is preferable to design the high-pass filter so as to pass the variations less than or equal to 83 px at the time of designing the high-pass filter. In the color adjustment processing including the high-pass filter, the low-frequency density unevenness resulting from the print head remains, which is removed by the high-pass filter. Because of this, even in a case where the high-pass filter is used at the time of the scan correction table generation, it is preferable to perform the color adjustment table generation processing again.

Detailed explanation of each piece of processing at S1101 to S1108 is omitted and each piece of processing at S1109 and subsequent steps is explained in the following.

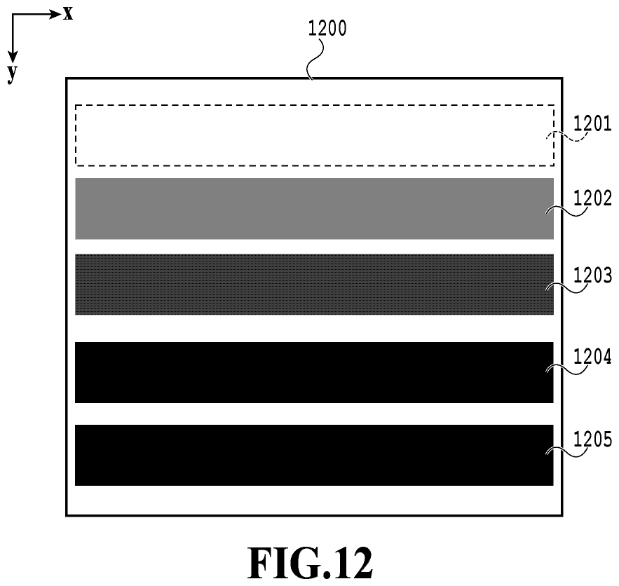

At S1109, the image data of the SS chart is read from the external storage device 105 or the ROM 102. FIG. 12 is a diagram showing one example of the SS chart. An SS chart 1200 shown in FIG. 12 comprises five measurement areas 1201 to 1205 whose tones are different from one another and each of which has a uniform color signal value.

At S1110, the color adjustment unit 302 performs the head shading correction processing for the image data of the SS chart by using print correction information on each nozzle, which is obtained by the processing at S1101 to S1108. The image data of the SS chart for which the head shading correction has been performed is converted into a halftone image by being subjected to halftone processing in the HT processing unit 305 and sent to the printing unit 107.

At S1111, the printing unit 107 performs print processing based on the halftone image data of the SS chart. By the processing up to this point, the SS chart from which high-frequency unevenness resulting particularly from the print heads 201 to 204 has been removed is obtained.

At S1112, the scan unit 108 generates scanned data of the SS chart by reading the SS chart output from the printing unit 107.

At S1113, the colorimetry unit 110 generates colorimetric data by measuring the color of the SS chart output from the printing unit 107. In the present embodiment, the eight colorimeters 110a to 110h each obtain the L*a*b* values as the colorimetric values.

At S1114, the scan correction information generation unit 304 generates two types of line profile for the SS chart based on the scanned data obtained at S1112 and the colorimetric data obtained at S1113, respectively. Further, at this step, processing to match the resolutions of both pieces of data with each other is also performed. In the following, a method of generating each line profile is explained.

### <<Generation of Line Profile Based on Scanned Data>>

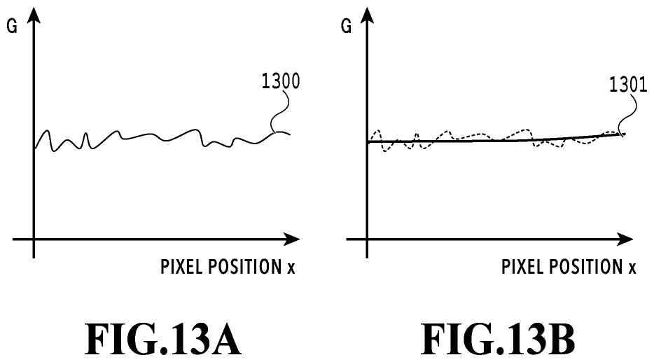

In a case where generation is based on scanned data, as at S1103, the generation is performed by identifying the image area corresponding to the measurement area of the SS chart from the scanned data and finding one-dimensional data obtained by averaging sensor values in the conveyance direction (y-direction). At this time, for the purpose of reducing noise resulting from the shot noise of the sensor and the like, as in the case of the generation of a line profile based on colorimetric data, to be described later, it may also be possible to perform function approximation with a polynomial. That is, from output values of a G (green) sensor for the pixel position x in the sensor column direction, such as those indicated by a curve 1300 in the graph in FIG. 13A, a curve of a cubic function as shown by a curve 1301 in the graph in FIG. 13B is found and this curve may be taken as a line profile. Alternatively, it may also be possible to take a curve obtained by using a low-pass filter, such as a median filter and a Gaussian filer, as a line profile in place of function approximation. In FIG. 13B, although only one curve is shown, in a case of the SS chart 1200 in FIG. 12, it is possible to obtain five line profiles corresponding to each of the measurement areas 1201 to 1205.

### <<Generation of Line Profile Based on Colorimetric Data>>

In a case where generation is based on colorimetric data, first, the colorimetric value corresponding to each measurement area is identified for each of the eight colorimeters 110a to 110h. Then, a line profile is obtained, which is converted data corresponding to the resolution (for example, corresponding to 600 dpi) in the sensor direction (x-direction) of the scanned data, by performing function approximation for the identified colorimetric value in each measurement area. In the following, detailed explanation is given with reference to the drawings.

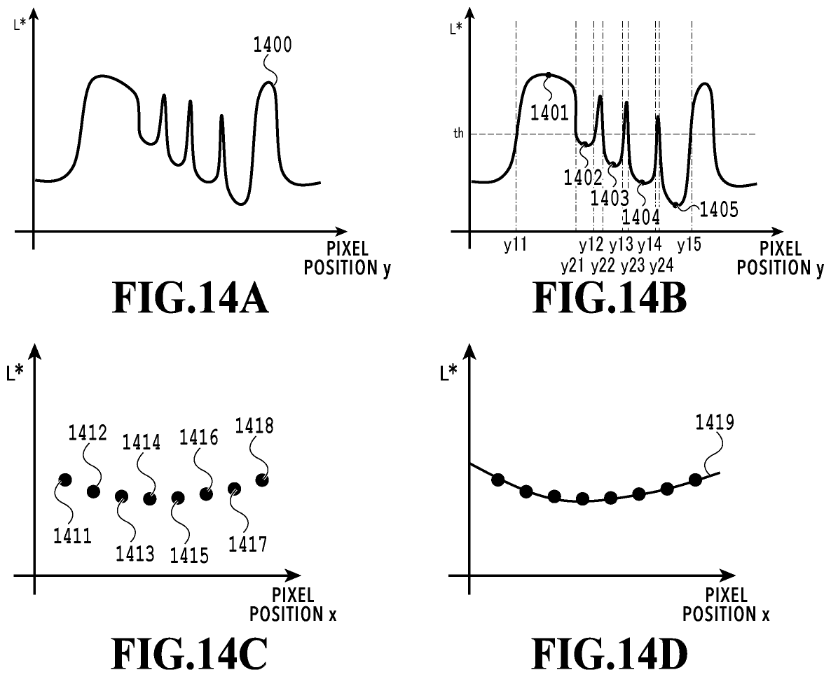

First, the processing for the y-direction is explained by using FIG. 14A and FIG. 14B. FIG. 14A is a graph in which colorimetric values recorded at predetermined intervals are plotted by taking the pixel position in the sheet feed direction (y-direction) along the horizontal axis and the L* value of the colorimetric values (L*a*b* values) along the vertical axis. The graph such as this is obtained for each of the eight colorimeters 110a to 110h. FIG. 14B is a graph in which a threshold value th is added to the graph in FIG. 14A. Here, five pixel positions y11 to y15 at which the L* value exceeds the threshold value th from under and four pixel positions y21 to y24 between the pixel positions y11 and y15, at which the L* value falls below the threshold value th from above are identified. In this case, as the colorimetric value corresponding to the measurement area 1201 of the SS chart 1200 shown in FIG. 12, it is possible to use the colorimetric value at a middle point 1401 between the pixel positions y11 and y21. Similarly, it may be possible to use the colorimetric value at a middle point 1402 between the pixel positions y21 and y12 for the measurement area 1202. Further, it is possible to use the colorimetric value at a middle point 1403 for the measurement area 1203, the colorimetric value at a middle point 1404 for the measurement area 1204, and the colorimetric value at a middle point 1405 for the measurement area 1205, respectively.

Next, the processing for the x-direction is explained by using FIG. 14C and FIG. 14D. FIG. 14C is a graph in which colorimetric values for the same measurement area by each of the colorimeters 110a to 110h are plotted by taking the pixel position x in the sensor column direction (x-direction) along the horizontal axis and the L* value of the colorimetric values (L*a*b* values) along the vertical axis. A curve 1419 shown in FIG. 14D indicates a function that approximates eight plotted points 1411 to 1418 shown in FIG. 14C by a polynomial of the pixel position x. It may be possible to calculate the function by using, for example, the publicly known least squares method and as the polynomial, for example, a cube function can be used. In FIG. 14D, although only one curve is shown, in a case of the SS chart 1200 in FIG. 12, it is possible to obtain five line profiles corresponding to each of the measurement areas 1201 to 1205.

Explanation is returned to the flowchart in FIG. 11.

At S1115, the scan correction information generation unit 304 initializes a pixel position of interest xi, which is the target of correction amount derivation. Specifically, the pixel position of interest xi=0 is set.

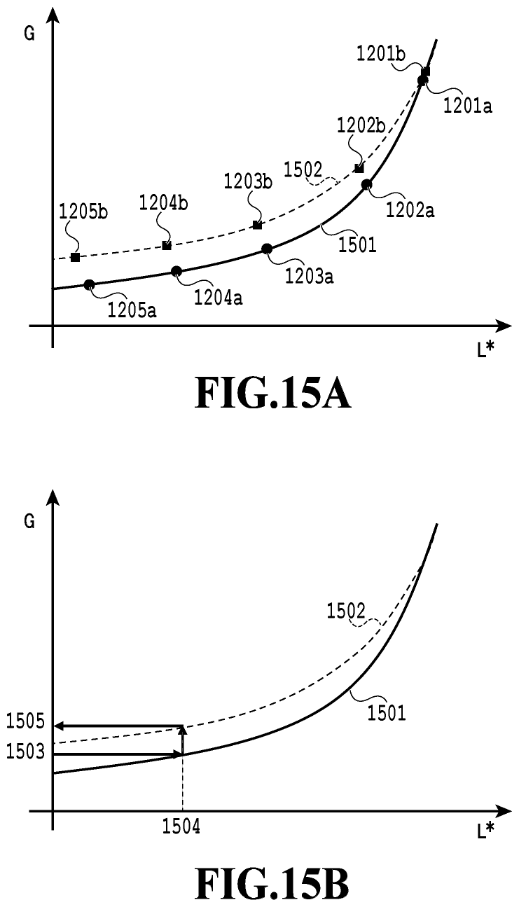

At S1116, the scan correction information generation unit 304 derives the correction amount for the pixel position of interest xi and determines the corrected sensor value for the pixel position of interest xi. By this processing, the corrected sensor values to be stored in the color adjustment table in FIG. 5 described previously, for example, “0, 29, 40, 240, 255”, which are the output values in a case where the pixel position x=0, are found. In the following, by using FIG. 15A and FIG. 15B, the derivation of the correction amount at this step is explained. FIG. 15A and FIG. 15B are each a graph in a case where the colorimetric value (L*) is taken along the horizontal axis and the sensor value of the G sensor (G channel value) of the RGB sensors configuring the line sensor is taken along the vertical axis. The graph in FIG. 15A shows points 1201a to 1205a obtained by plotting the colorimetric value (L*) and the G channel value of each of the measurement areas 1201 to 1205 at the pixel position x of the SS chart 1200. For example, the point 1201a represents the colorimetric value (L*) and the G channel value in the paper white measurement area 1201. Further, the point 1202a represents the colorimetric value (L*) and the G channel value in the palest gray measurement area 1202 and the point 1205a represents the colorimetric value (L*) and the G channel value in the darkest gray measurement area 1205. A curve 1501 in FIG. 15A is a curve that is obtained by using the interpolation calculation, such as the piecewise linear interpolation and the publicly known spline interpolation, or approximation processing for the plotted points 1201a to 1205a. A curve 1502 in FIG. 15A is the target reading characteristics representing the target value of the corrected sensor value. The target value is calculated from, for example, the colorimetric values of any one or more colorimeters and the sensor values corresponding to the colorimetry positions x thereof. In FIG. 15A, points 1201b to 1205b are each a point obtained by plotting the average of the colorimetric values of the two colorimeters 110d and 110e (see FIG. 2A) installed at the center and the average of the sensor values corresponding to the colorimetry positions x thereof. It may be possible to find the above-described curve 1502 by using the interpolation calculation or approximation processing for the points 1201b to 1205b as in the case of the curve 1501. It may also be possible to store in advance a curve representing the sensor reading characteristics taken to be a reference as the target reading characteristics and use it. Alternatively, it may also be possible to determine and store in advance a curve so that the sensor values are linear to the luminance, L*, and the optical density and use it. FIG. 15B is a diagram showing the way the corrected sensor value is determined from the two characteristic curves 1501 and 1502 thus obtained. In FIG. 15B, a G channel value 1503 represents the sensor value before correction and in the example in the scan correction table shown in FIG. 5, this corresponds to 0, 16, 32, 255. Here, a colorimetric value L* 1504 corresponding to the G channel value 1503 is obtained from the characteristic curve 1501. Further, from the target characteristic curve 1502, a target G channel value 1505 corresponding to the colorimetric value L* 1504 is obtained. The target G channel value 1505 thus obtained and the G channel value 1503 before correction are associated with each other and stored in the scan correction table being generated in association with the pixel position of interest xi. However, in a case where the sensor value before correction is 0 or the maximum output value (for example, 255), it may be possible to forcibly set the corrected sensor value to 0 or the maximum output value. By repeating the processing such as this the number of times corresponding to the number of rows of the scan correction table, the corrected sensor values at the pixel position of interest xi are determined.

Explanation is returned to FIG. 11, and at S1117 that follows, the scan correction information generation unit 304 determines whether all the sensor pixel positions are already processed as the pixel position of interest. Specifically, in a case where the pixel position of interest xi is larger than or equal the number of pixels comprised by the scan unit 108, it is determined that the processing is completed. Alternatively, in a case where the scan correction table in FIG. 5 is generated, it is sufficient to determine whether the processing has been performed for all the pixel positions 0, 100, 200, 300, 400, . . . , 3000, . . . in FIG. 5.

At S1117, whether all the pixel positions to be processed in the x-direction are already processed as the pixel position of interest is determined. In a case where there is an unprocessed pixel position, the processing advances to S1118 and the pixel position of interest xi is updated, and the processing returns to S1116 and the same processing is repeated. In a case where the pixel position in the x-direction is predefined at an interval of 100 as in the scan correction table shown in FIG. 5, in the updating processing at S1119, the pixel position of interest xi is increased by “100”. On the other hand, in a case where the processing is already performed for all the pixel positions to be processed in the x-direction, the processing advances to S1119.

At S1119, the scan correction table obtained by the processing up to this point is stored in the external storage device 105. At this time, in order to enable the determination based on the time elapsed from generation, the information about the sheet, such as the maker name, the model number, and the sheet type of the used sheet, the printing conditions, such as the print mode, and the date of generation are also stored in association with the scan correction table.

The above is the contents of the scan correction table generation processing. By performing the processing such as this for each ink color of CMYK, the scan correction table corresponding to each ink color is obtained. The generation of the scan correction table does not necessarily need to be performed for all the ink colors. It may also be possible to generate the scan correction table only for a specific ink color determined in advance. In that case, the sensor shading correction processing (S706) in the flow in FIG. 7 described previously is performed only for the specific ink color. As the example of the specific ink color such as this, there is yellow whose sensor value is likely to deviate between the center portion and the end portion for a uniform image.

### Modification Example

In the above-described embodiment, as the colorimetric value, the L* value is used and as the sensor value, the G channel value is used, which is the output value of the G sensor. However, particularly for the Y ink, it is empirically obvious that the L* value and the G channel value that are obtained are small for the amount of the forming ink. Consequently, it may also be possible to change the colorimetric value and the sensor value for each ink color. For example, for the K ink, the L* value and the G channel value are used as explained in the above-described embodiment, while for the Y ink, the b* value is used as the colorimetric value and the output value of the B sensor (B channel value) is used as the sensor value, and so on. Instead of using only one of the sensor output values (channel values) or one of the colorimetric values, it is also possible to use the value that is calculated from those. For example, as the colorimetric value, it may also be possible to use the color difference from the L*a*b* values of the sheet or specific L*a*b* values (L*=100, a*=0, b*=0). Alternatively, it may also be possible to use converted values that are obtained by performing 3×3 or 3×1 matrix conversion for the colorimetric values Lab and the sensor values RGB, respectively.

### Effects of the Present Embodiment

Here, the effects of the present embodiment are explained in comparison with the prior art. As described previously, the curve 1419 in FIG. 14D indicates the colorimetric values of a printed material that is formed for the uniform color signal value in the printing unit 107. Here, the curve 1419 is convex downward, and therefore, the formed image on the sheet surface is an ununiform image in which the end portion is bright compared to the center portion with respect to the pixel position x. On the other hand, the sensor values obtained by reading the formed image by the scan unit 108 are substantially uniform with respect to the pixel position x as indicated by the curve 1301 in FIG. 13B. That is, in this example, in the scan unit 108, the reading characteristics of each individual sensor are different depending on the pixel position x. In a case where head shading correction processing is performed by using the scan results of the scan unit 108 having the sensor in which there are variations of the reading characteristics, the density unevenness based on the sensor reading characteristics indicated by the curve 1419 in FIG. 4D occurs on the sheet surface. That is, inappropriate head shading correction that regards the sensor reading characteristics as the printing characteristics of the print head is performed.

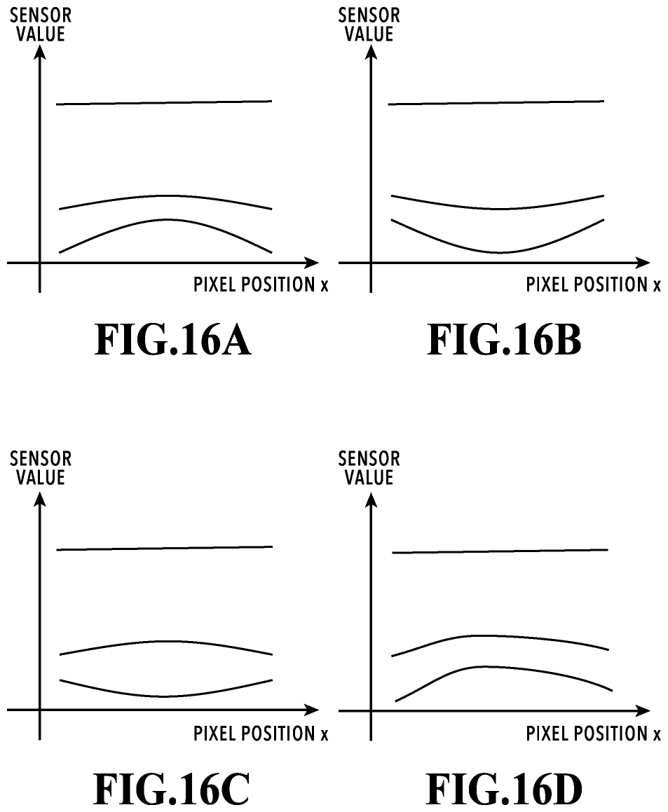

In many cases, the reading characteristics of the sensor depend on the incidence angle to the sensor pixel or the color filter and the read value gradually becomes high or low in accordance with the position of the sensor pixel. FIG. 16A to FIG. 16D are each a graph in a case where the pixel position x is taken along the horizontal axis and the sensor value is taken along the vertical axis, indicating variations of the sensor value with respect to the pixel position x. Then, each curve on the graph indicates an example of the sensor value at each pixel position x in a case where a plurality of density charts is read, whose spectral reflectance on the sheet surface is substantially the same irrespective of the position. It is assumed that the higher the reflectance of the density chart (that is, the closer the density chart to white paper), the larger the sensor value is, and that the lower the reflectance of the density chart (that is, the higher the density on the sheet surface), the smaller the sensor value is. As shown in FIG. 16A or FIG. 16B, in many cases, in the curve corresponding to the density chart whose sensor value is smaller, the deviation between the center portion and the end portion in the x-direction becomes larger. That is, in many cases, the higher the color signal value and the higher the image density on the sheet surface, the larger the difference in the reading characteristics of the sensor becomes. As one of the causes of this, it is considered that the incidence angle to the sensor becomes large at the end portion, and therefore, the light path on the color filer provided in the sensor pixel becomes longer. Specifically, it is considered that the change in the spectral distribution by the color filter for the light incident on the sensor becomes large at the end portion compared to that at the center portion and as a result of that, the sensor value changes. On the other hand, in a case where the incidence angle to the sensor is large, for example, it is considered that the light that should enter the G sensor enters the adjacent B sensor as stray light and this is also considered as one of the causes. In a case where these plurality of factors occurs at the same time, there is a possibility that the approximate shapes (convex upward and convex downward) of the reading characteristics of the sensor change in accordance with the average sensor value. Because of this, it is preferable for the above-described SS chart 1200 to include the measurement area uniform with a plurality of color signal values. Further, in a case where the internal structure of the scan unit 108 is not bilaterally symmetrical, there is a possibility that the shape is bilaterally asymmetrical as in FIG. 16D. The difference in the reading characteristics between the center portion and the end portion, which depends on the pixel position x, is likely to occur particularly in the B sensor. Because of this, in many cases, a problem arises in the head shading correction processing of the head 204 corresponding to the Y ink.

In order to deal with the phenomenon in which the sensor reading characteristics are different between the center portion and the end portion in the x-direction, in the present embodiment, the influence is lessened by the sensor shading correction processing (S706) at the time of the generation of the color adjustment table that is used in the color adjustment processing. That is, by using the scan correction table, each sensor value is converted into the color signal value corresponding to the reading results with the target reading characteristics (see the curve 1502 in FIG. 15A and FIG. 15B). That is, the influence of the difference in the sensor reading characteristics on the color adjustment processing is lessened by performing color adjustment processing based on the converted color signal value. For example, in a case where the target reading characteristics are set based on the sensor value and the colorimetric value thereof at the center portion, it is possible to perform the color adjustment processing with the sensor value corresponding to that in the case where the sensor value is read by the sensor at the center portion irrespective of the position of a printed material.

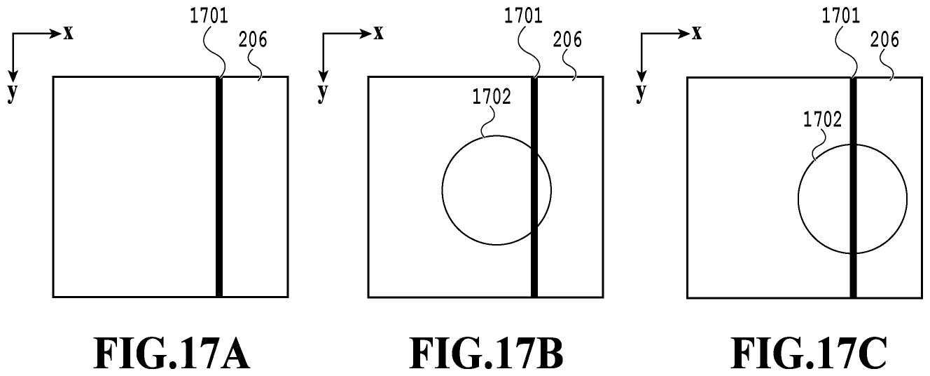

Incidentally, in the present embodiment, the SS chart is printed and output in the printing unit 107, which is the target of color adjustment processing. Because of this, there is a case where a streak or unevenness resulting from the print heads 201 to 204 is included in the formed image of the SS chart. In this case, particularly on a condition that high-frequency unevenness or a high-frequency streak is included in the SS chart, it is not possible to appropriately calculate the correction amount that is applied to sensor shading correction, and therefore, it is no longer possible to sufficiently correct the difference in the sensor reading characteristics. Here, with reference to FIG. 17A to FIG. 17C, the principle thereof is explained. On the sheet 206, a thin streak 1701 extending along the conveyance direction (y-direction) exists. A circle 1702 in FIG. 17B and FIG. 17C represents a circular opening of the colorimetry unit 110 and it is assumed that the diameter of the circle 1702 is greater than the width in the x-direction of the thin streak 1701. As shown in FIG. 17B and FIG. 17C, depending on the way the streak 1701 intersects the opening, the ratio of the streak included in the opening is different and as a result of that, the obtained colorimetric value also varies. However, the area in which it is possible for the plurality of the fixed colorimeters 110a to 110h to perform colorimetry is limited, and therefore, it is difficult to estimate the colorimetry position and perform position adjustment with so high an accuracy that enables the determination of the degree of interference between the opening 1702 of the colorimetry unit 110 and the streak 1701. Further, even though it is possible to perform position adjustment, the influence of the streak on the sensor values (RGB values) and the influence of the streak on the spectral reflectance of the colorimeter are different. Because of this, it is difficult to remove the influence of the steak on the sensor value from the colorimetric value. Here, it is assumed that the RGB values, which are each the sensor value, are averaged by performing the extraction of the colorimetry area thereof with accuracy for the colorimetric value obtained with the influence of the streak on the spectral reflectance included. Even in this case, the possibility is strong that the relationship between the colorimetric value thus obtained and the sensor value and the relationship between the colorimetric value in a case where there is no streak and the sensor value are different due to the influence of MTF and γ of the sensor. Further, in the present embodiment, from the limited colorimetric values of only the colorimeters 110a to 110h whose positions are fixed, the sensor reading characteristics at all the pixel positions in the x-direction are obtained by function approximation, and therefore, the influence of the error on the whole is large, which occurs at each colorimetry position. For example, in a case where a streak occurs in the area corresponding to the colorimeter 110e despite that the scan unit 108 has the reading characteristics shown in FIG. 16A with respect to the pixel position x, there is a possibility that the scan correction table is generated with the reading characteristics shown in FIG. 16D. There is a case where the scan correction table generated in the state where there is a streak as described above is not appropriate to the reading characteristics of the scan unit 108.

Consequently, in the present embodiment, by performing the color adjustment processing prior to the generation of the SS correction table (S1110 in the flow in FIG. 11), the streak and unevenness resulting from the print head are removed. By this color adjustment processing, it is made possible to lessen the influence of the variations of the colorimetry position accompanying the sheet conveyance and the difference in the color space between the sensor and the colorimetric value. On the other hand, by the color adjustment processing prior to the generation of the scan correction table, low-frequency density unevenness resulting from the sensor occurs on the sheet surface. That is, despite that the sensor values are substantially uniform (see FIG. 13B), an image is formed, in which the colorimetric value is different between the end portion and the center portion. In the present embodiment, after the generation of the scan correction table, the sensor shading correction processing using the generated scan correction table is further performed, and then the color adjustment table is generated (S706 in the flow in FIG. 7). Due to this, the influence of the low-frequency density unevenness resulting from the sensor is lessened.

### Another Modification Example

It is possible to reduce the difference in the ejection characteristics between nozzles by the color adjustment processing using the above-described HS chart (head shading correction processing, S1101 to S1110). Specifically, it is sufficient to increase or decrease the ejection amount per unit area of the nozzle based on the density at the position corresponding to each nozzle. However, there is a case where only increasing or decreasing the ejection amount of the nozzle is not sufficient for a non-ejection nozzle that hardly ejects ink or a defective nozzle whose ejection amount is not stable. In such a case, processing to change the ejection amount of a peripheral nozzle, not the nozzle in question, becomes necessary separately. Consequently, it is preferable to detect a non-ejection nozzle and a defective nozzle with a dedicated chart before starting the scan correction table generation processing (S1101 to S1119). Further, in a case where a non-ejection nozzle or a defective nozzle is detected, it is preferable to make an attempt to bring about recovery by cleaning processing, perform complementary processing to distribute the number of dots to be ejected to the nozzle adjacent to the detected nozzle, and so on.

In the above-described embodiment, the SS chart is prepared separately from the HS chart, but it is also possible to use the HS chart as the SS chart in a sharing manner. However, in many cases, the color signal values to be focused on are different between the color adjustment processing and the sensor shading correction processing. Because of this, it is preferable to prepare a chart in which more color signal values to be focused on are arranged for each. Alternatively, by arranging only the color signal values to be focused on for each, it is possible to suppress the number of measurement areas and save the number of sheets to be used. For example, the streak and unevenness on the sheet surface, which are the target of the color adjustment processing, are more likely to be perceived in the image area whose color signal value is comparatively small (low-density area). On the other hand, the deviation between the center portion and the end portion in the x-direction, which is the target of the sensor shading correction processing, is likely to occur in the image area whose color signal value is comparatively large (high-density area). Because of this, it is preferable to increase the ratio of the high-density patches in the SS chart. Further, in the SS chart, the ruler (the position adjustment pattern 810 in FIG. 8) for associating the nozzle position and the sensor position with each other is not necessary. Because of this, by not arranging the ruler in the SS chart to make it more compact, it is possible to save the number of sheets to be used compared to the case where the HS chart is used as the SS chart in a sharing manner. Further, in a case where it is possible to arrange the patch of each color of CMYK in one image en bloc, it is possible to further save the number of sheets.

In the above-described embodiment, the color adjustment table stores the color signal values before and after correction for each print head and the scan correction table stores the sensor values before and after correction for each pixel position. However, it may also be possible for the color adjustment table to store the color signal values before and after correction by a table independent for each print head and for the scan correction table to store the sensor values before and after correction by a table independent for each pixel position.

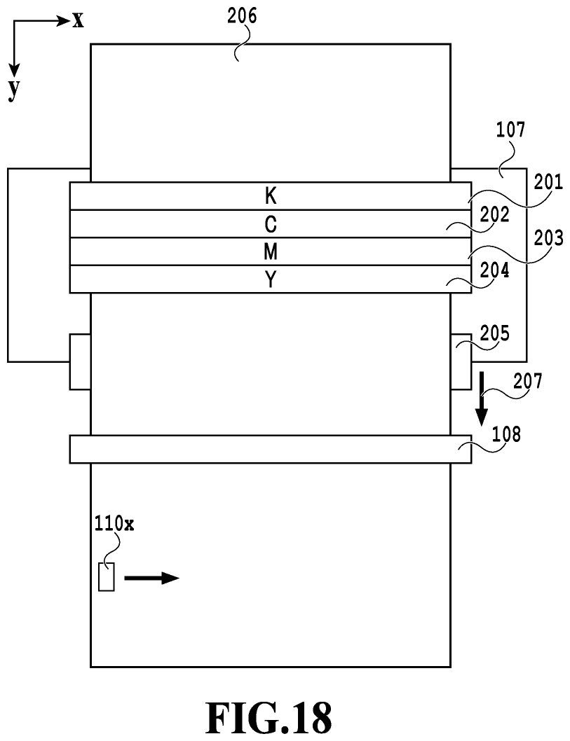

In the above-described embodiment, the case is supposed where the change in the sensor reading characteristics in the sensor column direction (x-direction) is comparatively gradual and the colorimetric values by the eight colorimeters 110a to 110h whose positions are fixed are used. However, the more rapid the change in the sensor reading characteristics, the more densely it is necessary to arrange the colorimeters in order to obtain the variations of the reading characteristics in the x-direction. In a case where the number of colorimeters is increased, in addition to the cost being raised accordingly, it becomes difficult to arrange the colorimeters so that there is no interference between the colorimeters, and such a problem that the casing size increases will occur. Further, there is an individual difference between the colorimeters and the colorimetric characteristics are not uniform, and therefore, in a case where the difference such as this is corrected separately outside, more time and effort will be required for the correction as the number of colorimeters increases. Consequently, in a case where it is intended to install more colorimeters, it is preferable to use a single colorimeter 110x that performs a scan in the direction (x-direction) parallel to the line sensor as shown in FIG. 18 in place of fixing each colorimeter. In this case, in the colorimetry of the SS chart (S1113), the colorimeter 110x performs a scan in the direction (x-direction) perpendicular to the conveyance direction (y-direction). During a scan, the sheet is not conveyed and after the colorimetry is completed, the sheet is conveyed by an amount corresponding to the height between the measurement areas. Then, the colorimeter 110x performs a scan and colorimetry on the next measurement area. By repeating the conveyance of the sheet and the scan and colorimetry of the colorimeter 110x as described above the number of times corresponding to the number of colorimetry areas, it is possible to obtain the colorimetric value corresponding to each colorimetry area. The colorimetric value thus obtained is obtained as the line profile for the pixel position x. Consequently in a case where the colorimetric values at a sufficient number of points are obtained, the processing to generate the line profile for the colorimetric values (S1114) is no loner necessary. However, in order to reduce colorimetry errors of the colorimeter or in a case where the number of colorimetry points in the x-direction is small, it may also be possible to take the results of performing approximation processing by function approximation as the line profile. Compared to the configuration (see FIG. 2) in which a plurality of colorimeters is fixed, with the configuration (see FIG. 18) in which the colorimeter performs a scan, the scanning mechanism of the colorimeter and the sheet handling at the time of colorimetry become complicated. Because of this, it may also be possible to perform colorimetry off-line by using an external colorimeter in place of providing the colorimeter inside the apparatus and performing colorimetry on-line. In this case, it may also be possible to manually perform colorimetry of the SS chart (S1113) by taking out the printed and output SS chart from the image forming apparatus. In this case, it is sufficient to input the colorimetric value obtained from the colorimeter that is slid manually on each colorimetric area within the SS chart through the operation unit 103 and the I/F unit 109. Alternatively, it is also possible to fix the SS chart on the x-y stage and perform colorimetry on each measurement area within the SS chart.

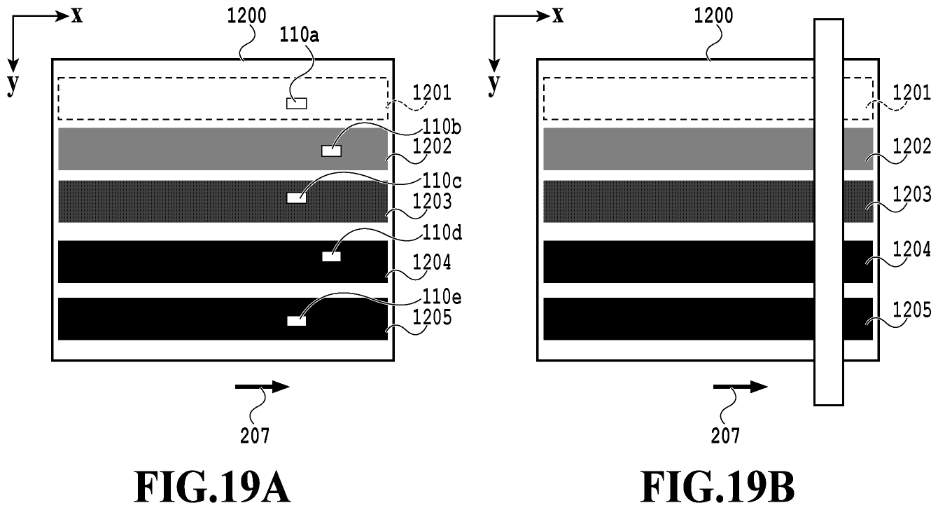

Further, as shown in FIG. 19A, it may also be possible to obtain the line profile for the pixel position x by rotating the conveyance direction of the sheet by 90° with respect to the conveyance direction at the time of printing, conveying the sheet, and performing colorimetry. In this case, the printed and output SS chart is taken out of the image forming apparatus and after the SS chart is rotated by 90°, the SS chart is set to the image forming apparatus again. For the sheet that is set again, the image formation by each print head and the reading by the scan unit 108 are not performed but only the colorimetry by the colorimeters 110a to 110e is performed. It may also be possible to prepare, for example, a flat-bed scanner or the like separately and use the value read by the scanner as the above-described colorimetric value in place of using the colorimeter. Further, as shown in FIG. 19B, it is preferable to read the sheet by rotating the conveyance direction of the sheet by 90° with respect to the conveyance direction at the time of printing. By arranging the sheet like this, it is possible to read each colorimetry area with substantially the same sensor and derive the correction amount with higher accuracy.

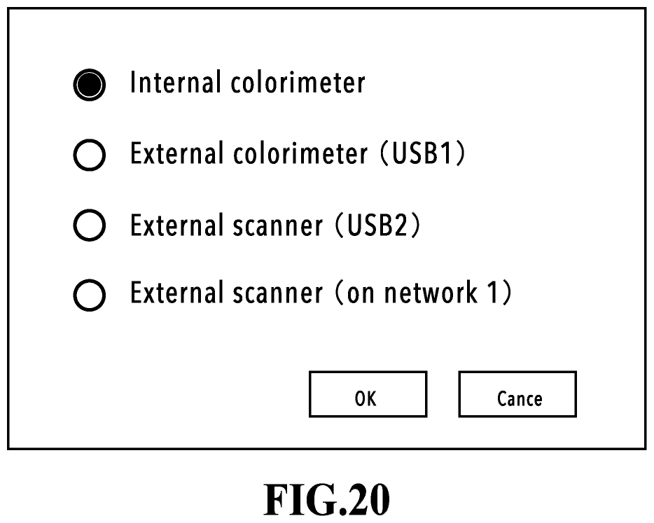

Further, it may also be possible to enable the colorimetric value obtained by sliding the external colorimeter to be input through the operation unit 103 or the I/F unit 109 while comprising the limited number of fixed colorimeters inside the image forming apparatus. In this case, for example, it may also be possible to generate the scan correction table based on the colorimetric value by the external colorimeter upon receipt of the explicit instructions of a user while performing the scan correction table generation processing automatically and at predetermined intervals by using the internal colorimeter. In a case where the internal colorimeter and the external colorimeter are used differently depending on situations, it is preferable for the internal colorimeter to be a fixed type whose mounting is easier and for the external colorimeter to be a scan-type colorimeter capable of obtaining higher-frequency information. For example, in a case where a user can check that high-frequency density unevenness has occurred on a printed material, which seems to result from the sensor reading characteristics, by visual inspection, it is sufficient for the user to give instructions to perform the scan correction table generation processing based on the colorimetric value of the external colorimeter. Alternatively, it is sufficient to give instructions in a case where a new sheet is set, in a case where the scan unit 108 is replaced with another, or in a case where a predetermined time elapses from the scan correction table generation. In order to make it easy for a user to give the instructions, it may also be possible to give a warning or notification to the user through the display unit 104 in a case where a new sheet is set, in a case where the scan unit 108 is replaced with another, or in a case where a predetermined time elapses from the scan correction table generation. At that time, for convenience of a user, it is preferable to enable the user to directly give the instructions to perform the scan correction table generation processing from a user interface screen (UI screen) for giving a warning or notification. In a case where it is also made possible to input the colorimetric value from the external colorimeter while comprising the internal colorimeter, it is necessary to select the colorimeter whose colorimetric value is to be used at the time of scan correction table generation. FIG. 20 is one example of the UI screen for a user to select the colorimeter. The UI screen in FIG. 20 is configured to show the internal colorimeter and the external colorimeter or the external scanner that can be accessed via the I/F unit 109 in a list and enable a user to select one from the list. It is sufficient to display the UI screen presenting the available colorimeter such as this on the operation unit 103 and enable a user to select the colorimeter or the scanner to be used. For example, control is performed so that the scan correction table is generated without fail without performing the determination of whether or not the scan correction table can be used (S701) in the flow in FIG. 7 described previously. Then, it may also be possible to cause a user to select the colorimeter to be used each time by displaying the UI screen in FIG. 20 on the display unit 104 at the time of the execution of the sensor shading correction processing (S706).

### Second Embodiment

In the first embodiment, the aspect is explained in which the scan correction table (FIG. 5) that associates the sensor value at each pixel position and the corrected sensor value with each other is generated and the sensor shading correction processing is performed by using this.

By the way, the sensor value that is obtained from the non-print area (paper white area) on a sheet, which is read by the scan unit 108, changes depending on the type of sheet. For example, compared to high-quality paper and coated paper, on the paper surface of recycled paper, the reflectance is generally low, and therefore, in many cases, the sensor value of the paper white area of recycled paper is a value small compared to that of high-quality paper and coated paper. Further, between the same high-quality paper, there is a case where the RGB values (particularly, the B channel value) are different depending on the presence/absence of a specific component (for example, optical brightener) within the sheet. As a result of that, in a case where the sheet to be used has characteristics different from those of the sheet used at the time of the scan correction table generation, the accuracy of the sensor shading correction processing decreases. As regards this point, it is also considered to avoid a reduction in accuracy by generating the scan correction table for each of the sheet characteristics, but in this case, the load of work to prepare the tables considerably increases.

Consequently, an aspect is explained as a second embodiment in which in a case where the characteristics of the sheet to be used are different between the time of the generation of the scan correction table and the time of the application thereof, by further performing calibration processing to substantially match the sensor values in the paper white area, the influence of the variations of the sensor values resulting from the difference in the sheet characteristics is suppressed.

### <Details of Image Processing Unit>

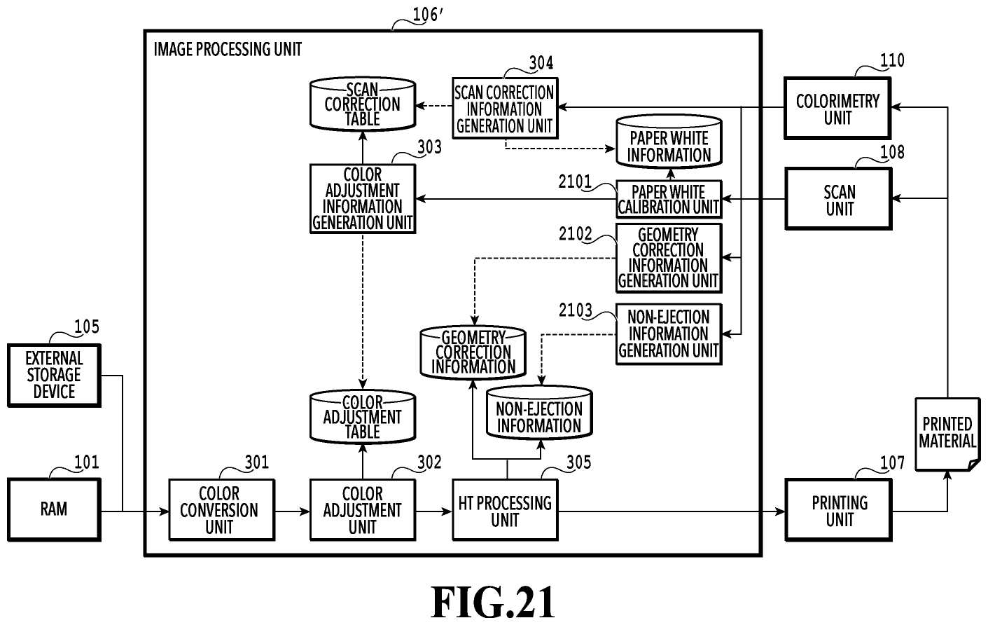

FIG. 21 is a diagram showing the internal configuration of an image processing unit 106′ according to the present embodiment. The image processing unit 106′ of the present embodiment has a paper white calibration unit 2101, a geometry correction information generation unit 2102, and a non-ejection information generation unit 2103, in addition to each configuration unit of the image processing unit 106 shown in FIG. 3 of the first embodiment.

The paper white calibration unit 2101 performs calibration processing to convert the sensor value in the paper white area into a predetermined value (in the following, called “paper white calibration processing”) for the scanned data of the HS chart, which is received from the scan unit 108. In the present embodiment, the color adjustment information generation unit 303 generates a color adjustment table based on the scanned data for which the paper white calibration processing has been performed. Details of the paper white calibration processing will be described later.

The geometry correction information generation unit 2102 generates geometry correction information for correcting the relative position shift and inclination of the above-described print heads 201 to 204 and the module configuring each print head. As the method of generating geometry correction information, it may be possible to apply a publicly known technique. The generated geometry correction information is used for processing to correct the position shift and inclination for the binary data for which the HT processing has been performed in the HT processing unit 305.

The non-ejection information generation unit 2103 generates, for example, a list of the numbers of abnormal nozzles as non-ejection information, with which it is possible to identify an abnormal nozzle not capable of ejecting ink normally. As the method of generating non-ejection information, it may be possible to apply a publicly known technique. The generated non-ejection information is used for processing to complement the formation of a dot, which should have been performed by the abnormal nozzle, by another normal nozzle for the binary data for which the HT processing has been performed in the HT processing unit 305.

The geometry correction information generation unit 2102 and the non-ejection information generation unit 2103 are not the components unique to the present embodiment and the additional processing using the geometry correction information and non-ejection information may be performed in the first embodiment.

### <Color Adjustment Table Generation Processing>

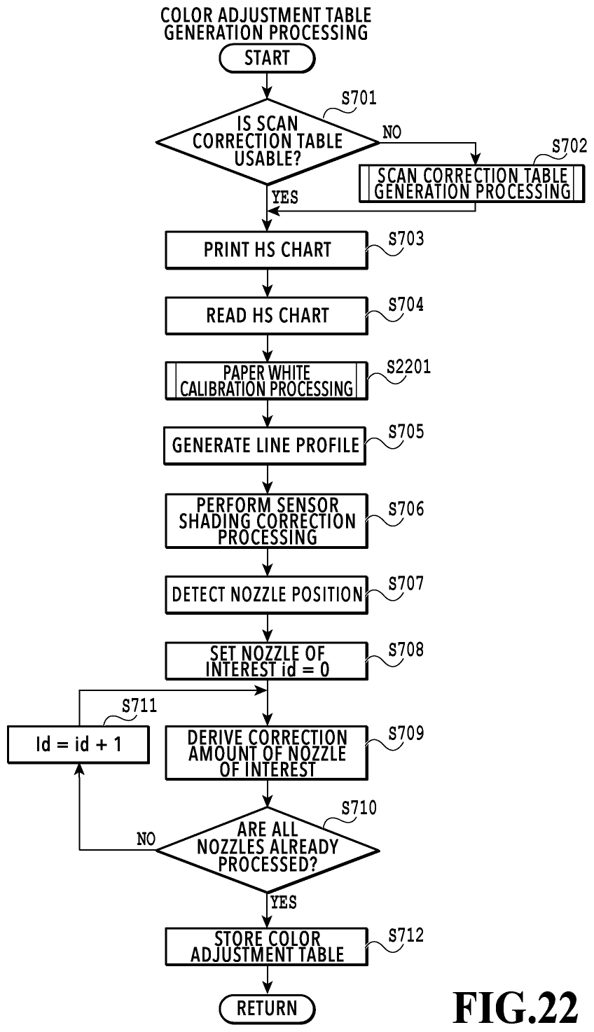

The flowchart shown in FIG. 22 is a diagram showing the flow of the color adjustment table generation processing (S603) in the present embodiment and corresponds to the flowchart in FIG. 7 in the first embodiment. The flowchart shown in FIG. 22 differs from the flowchart in FIG. 7 described previously in that paper white calibration processing (S2201) is added. Details of the paper white calibration processing will be described later.

### <Scan Correction Table Generation Processing>

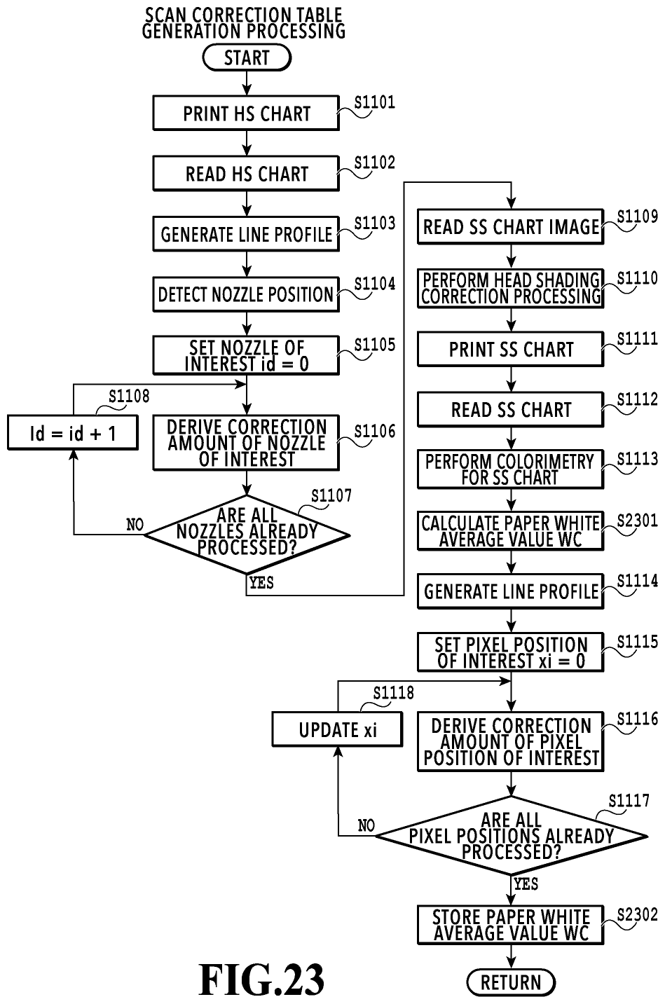

The flowchart shown in FIG. 23 is a diagram showing the flow of the scan correction table generation processing (S702) in the present embodiment and corresponds to the flowchart in FIG. 11 in the first embodiment. The flowchart shown in FIG. 23 differs from the flowchart in FIG. 11 described previously in that processing (S2301) to calculate a value (in the following, described as “paper white average value”) W0 obtained by averaging the sensor values in the paper white area and processing (S2302) to store the paper white average value W0 as paper white information are added. In the following, explanation of the contents common to those of the flowchart in FIG. 7 described previously is omitted and the processing (S2301) to calculate the paper white average value W0 and the processing (S2302) to store the paper white information are explained, which are the features of the present embodiment.

At S2301, the scan correction information generation unit 304 calculates the paper white average value W0 from the scanned data obtained at S1112. Specifically, processing to identify, for example, the measurement area 1201 as the non-print area on the SS chart 1200 and obtain the sensor values within the area, and then find the average value thereof is performed. The target area for which the paper white average value W0 is calculated may be, for example, the margin portion outside the measurement area.

At S2302, the scan correction information generation unit 304 stores the paper white average value W0 calculated at S2301 in the RAM 101 as paper white information.

The above is the scan correction table generation processing according to the present embodiment. It may also be possible to perform the processing at S2301 by taking a plurality of non-print areas as the target and further find the average of the paper white average value W0 obtained from each non-print area and store the average as paper white information.

### <Paper White Calibration Processing>

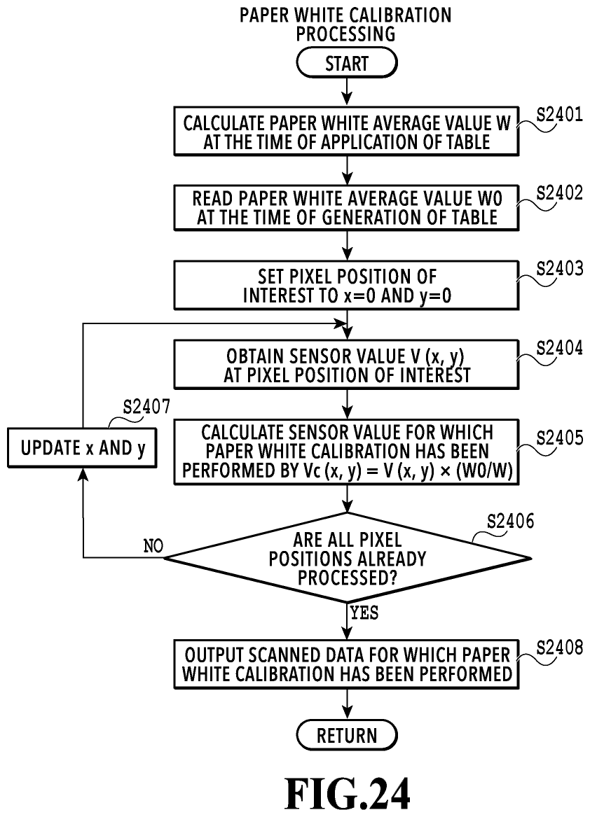

Next, the paper white calibration processing by the paper white calibration unit 2101 is explained. FIG. 24 is a flowchart showing details of the paper white calibration processing. In the following, explanation is given along the flowchart in FIG. 24.

First, at S2401, the calculation of a paper white average value W at the time of the application of the table is performed for the scanned data of the HS chart 800, which is obtained at S704. Specifically, as at S2301, processing to identify, for example, the measurement area 801 as the non-print area on the HS chart 800 and obtain the sensor values within the area, and then find the average value thereof is performed. At this time, it is preferable to use the same area as the area on the sheet surface, for which the calculation of the paper white average value W has been performed at S2301 described above. The reason is that in a case where different areas are used respectively, such as a case where the margin area is used on one hand and the measurement area is used on the other hand, the different in the way the illumination is provided and in the influence of backing affects the calculation results and there is a possibility that the accuracy of the correction using the paper white information decreases. As at S2301 described above, it may also be possible to perform the calculation of the paper white average value W at S2401 by taking a plurality of non-print areas as the target.

At S2402, the paper white information at the time of the generation of the scan correction table is obtained, which is stored at S2302. Specifically, the paper white average value W0 is read from the RAM 101.

At S2403, a pixel position of interest (x, y) is initialized, which is the target of the paper white calibration processing. Specifically, the pixel position of interest (x, y)=(0, 0) is set.

At S2404, a sensor value V (x, y) at the pixel position of interest (x, y) is obtained.

At S2405, the calculation of a calibrated sensor value Vc (x, y) at the pixel position of interest (x, y) is performed. It is possible to find the calibrated sensor value Vc by multiplying the sensor value V (x, y) before calibration by a paper white calibration value W0/W, that is, by Vc (x, y)=V (x, y) x W0/W.

At S2406, whether the calibrated sensor value Vc (x, y) is already calculated for all the pixel positions of the scanned data of the HS chart, which is obtained at S704, is determined. In a case where there is an unprocessed pixel position, the processing advances to S2407 and the pixel position of interest (x, y) is updated, and the processing returns to S2404 and the same processing is repeated. On the other hand, in a case where the processing is already completed for all the pixel positions, the processing advances to S2408.

At S2408, the scanned data (scanned data for which paper white-calibration has been performed) in which the sensor value V of each pixel is converted into the calibrated sensor value Vc is output to the color adjustment information generation unit 303.

The above is the contents of the paper white calibration processing of the present embodiment. As described above, in the paper white calibration processing, processing to find the paper white calibration value W0/W from the paper white average value W0 at the time of the generation of the table and the paper white average value W at the time of the application of the table and multiply each pixel by this paper white calibration value W0/W is performed. Due to this, it is possible to approximately match the sensor value obtained from the paper white area at the time of the generation of the scan correction table with that at the time of the application of the scan correction table.

### (Number of Channels of Sensor Value)

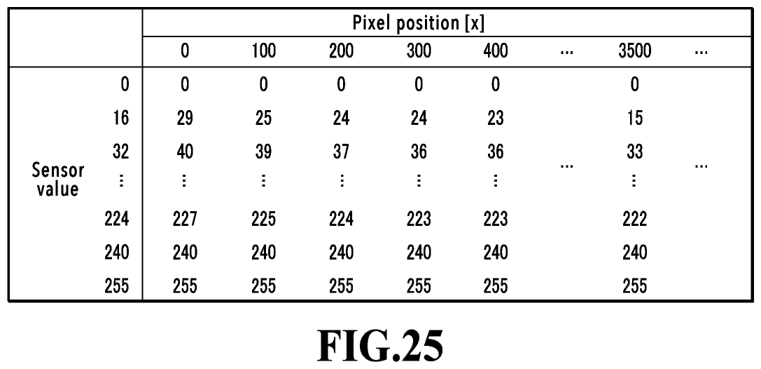

FIG. 25 is one example of the scan correction table in the present embodiment. As in the scan correction table shown in FIG. 5, in the scan correction table of the present embodiment also, the sensor value of one channel and the corrected sensor value are associated with each other. Here, in a case where a luminance sensor or a density sensor is used as the image sensor within the scan unit 108, the sensor value is luminance or density data of one channel. Then, the color adjustment information generation unit 303 also generates a color adjustment table based on the sensor value irrespective of the ink color. Because of this, it is sufficient for the scan correction table also to store the corrected value corresponding to the sensor value and the paper white average value W0 as paper white information is also data of one channel. On the other hand, in a case where a color sensor is used as the image sensor within the scan unit 108, for example, data of three channels of RGB is obtained as the sensor value. As explained in the modification example of the first embodiment, there is a case where the color adjustment information generation unit 303 corrects the color adjustment table by using the data of one channel in accordance with the ink color. For example, the value of the G channels is used as the sensor value for the M ink and K ink, the value of the R channel is used as the sensor value for the C ink, the value of the B channel is used as the sensor value for the Y ink, and so on. In a case where the channels are switched in accordance with the ink color as described above, it is preferable to store in advance the data of the three channels, which is obtained by performing averaging for each channel of RGB, as paper white information. Further, it is preferable to obtain the value of the channel that is used by the color adjustment information generation unit 303 at S2402 as the paper white average value W0.

### Effects of the Present Embodiment

Here, the effects of the present embodiment are explained. Here, it is assumed that the paper white average value W0 at the time of the generation (S702) of the scan correction table shown in FIG. 25 is “240”. At this time, generally, paper white is obtained as a substantially constant sensor value irrespective of the pixel position by the shading correction processing with the white reflection standard, which is performed within the scan unit 208. Consequently, also in the example of the scan correction table shown in FIG. 25, for the sensor value “240”, the corrected sensor value is “240”, which is the same as that before correction, irrespective of the pixel position. On the other hand, for the sensor value “224”, the values are different depending on the pixel position. By generating the scan correction table as described above, it is possible to correct variations of the sensor characteristics depending on the pixel position, which result from the angle dependence of the sensor and illumination, the surface characteristics of the sheet and the like.

A case is considered where the scan correction table shown in FIG. 25 is applied to a sheet (for example, a sheet whose white level is low compared to that of the sheet at the time of the generation of the scan correction table) whose type is different from that of the sheet used at the time of the generation thereof. Here, it is assumed that the paper white average value W in the scanned data at S704 is “224”. At this time, because the sensor value “224” is the sensor value for the paper whiter area, the sensor value is substantially constant irrespective of the pixel position, and therefore, it should be not necessary to change the sensor value before and after the correction by the scan correction table. However, in a case where the sensor shading correction processing (S706) is performed for the line profile calculated from the scanned data, the correction for the sensor value “224” is performed and the sensor value changes as a result. As described above, in a case where the sensor value in the paper white area at the time of the generation (S702) of the scan correction table is different from that at the time of the application (S706) of the scan correction table, there is a possibility that the correction is not performed successfully.

In the present embodiment, prior to the application of the scan correction table, by the paper white calibration processing (S2201), the sensor value of the paper white area is converted so as to be the same value as that at the time of the generation of the scan correction table, and therefore, it is possible to reduce the correction error particularly at the bright portion.

### Modification Example 1

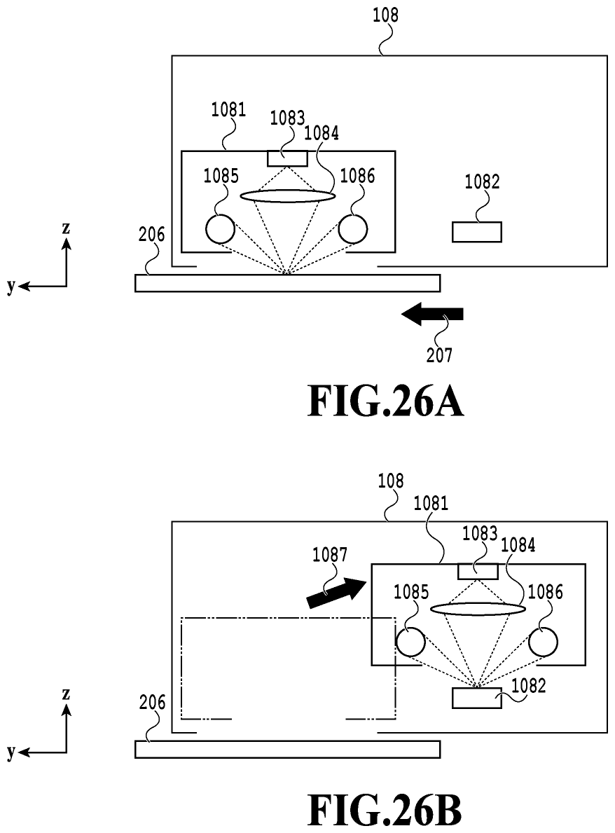

Even between the sheets of the same type having the same characteristics, there is a case where a difference arises in the sensor value of the paper white area on a condition that, for example, the makers are different, the production lots are different even though the brand is the same, or the like. Further, there is also a case where the results of scanning exactly the same sheet a plurality of times are different. FIG. 26A is a cross-sectional diagram in a case where the scan unit 108 at the time of scanning a sheet is cut in a plane parallel to the x-axis. To the same element as that in FIG. 2A, the same symbol is attached. Further, in FIG. 26A, the Z-axis is the direction corresponding to the thickness of the sheet 206 and is the axis perpendicular to the width direction X and the conveyance direction Y of the sheet. As shown in FIG. 26A, the scan unit 108 comprises a sensor casing 1081 and a white reflection standard 1802. Further, the sensor casing 1081 internally comprises a line sensor 1083, which is a light receiving unit, a lens array 1084, and light sources 1085/1086. In the line sensor 1083, imaging elements that convert the brightness of light into an electrical signal are arranged side by side linearly, in one row, or in a plurality of rows in the X-axis direction. Because of this, it is possible to detect the synthetic light of the light sources 1085 and 1086, which is reflected from the sheet surface, across the entire width of the sheet 206 (X-axis direction). Further, by detecting the reflected light while conveying the sheet in the direction indicated by the arrow 207 in FIG. 26A at predetermined speed, it is possible to scan the entire area of the sheet 206. FIG. 26B is a cross-sectional diagram of the scan unit 108 in a case where the white reflection standard 1082 is read. In FIG. 26B, the white reflection standard 1082 is, for example, a metal plate uniformly painted white, or to which a white sheet is pasted and whose length is greater than the width of the line sensor 1083 in the X-direction, and fixed to the casing of the scan unit 108. As shown in FIG. 26B, in a case where the white reflection standard 1082 is read, the entire sensor casing 1081 moves in the direction of an arrow 1087 up to the position facing the white reflection standard 1082 by the drive of, for example, a motor not shown schematically. By detecting the reflected light at the position facing the white reflection standard 1082 as above, it is possible to read the white reflection standard 1082. By this reading, it is possible to obtain the signal value of each imaging element configuring the line sensor 1083 for the white reflection standard 1082. In the above-described configuration, it is preferable for both the reading of the sheet 206 shown in FIG. 26A and the reading of the white reflection standard 1082 shown in FIG. 26B to be performed in the state where the sheet surface and the white reflection standard are located at the focal position of the lens array 1084 and the light sources 1085/1086. However, depending on the accuracy of the conveyance of the sheet 206 and the accuracy of movement toward the direction of the arrow 1087, there is a case where the sheet surface and the white reflection standard are not located at the focal position. Alternatively, there is also a case where the expansion or the like of each part is caused as the temperature within the sensor casing 1081 rises and the focal position shifts. That is, even in a case where the sheets having the same characteristics are used, the intensity of the light that reaches the sensor irrespective of the reflectance on the sheet surface may vary due to the shift of the sensor from the focal position, the shift of the focus of illumination, the balance with the light sources 1085 and 1086 accompanying thereto, and the like. In the case such as this, even though the sheet having the same characteristics is used both at the time of the generation (S702) and at the time of the application (S706) of the scan correction table, it is preferable to perform the above-described paper white calibration processing.

### Modification Example 2

It is also possible to generate and store a plurality of scan correction tables. That is, it is also possible to employ a configuration in which a scan correction table is generated for each of a plurality of sheets whose characteristics (for example, white level) are different and the paper white average value W0 at the time of generation is stored in association with the corresponding scan correction table. At this time, in a case where the above-described paper white average value W0 is obtained (S2402), it is preferable to select the scan correction table with which the paper white average value W0 the closest to the paper white average value W is associated based on the paper white average value W calculated at S2401. As described above, by selecting the scan correction table whose sensor values of the paper area are close at the time of generation (S702) and at the time of application (S706), it is possible to expect that the correction error for, particularly the dark portion and the high-saturation portion, which is caused by paper white calibration, are reduced. Further, it may also be possible to generate a plurality of scan correction tables in accordance with the temperature within the sensor casing 1081. For example, it may also be possible to generate in advance two patterns, that is, one for the temperature (for example, 25 degrees) at the time of the power source of the apparatus being turned on and the other for the temperature (for example, 40 degrees) at the time of the apparatus being in the stable operation and select the table to be used in accordance with the current temperature or the time elapsed from the start of the operation. Further, for example, it may also be possible to separately generate in advance tables in a case where printing is performed using a mixture of a plurality of types of sheet whose thickness is different (for example, plain paper is used for a monochrome page and coated paper is used for a color page) and select the table to be applied in accordance with whether the print job uses only the single type of sheet or a mixture of a plurality of types of sheet.

### Modification Example 3

In the flow of the paper white calibration processing shown in FIG. 24 described above, it may also be possible to additionally perform processing to determine whether or not it is possible to perform paper white calibration. Specifically, before the start of S2403, a step of determining whether or not it is possible to perform paper white calibration by using the paper white average value W at the time of the application of the table obtained at S2401 and the paper white average value W0 at the time of the generation of the table obtained at S2402 is added. Then, in a case where the absolute value of the difference between W and W0 is less than or equal to a threshold value th1 determined in advance, the processing at S2403 to S2406 may be omitted. In this manner, in a case where the difference between W0 and W is sufficiently small, it may also be possible to deliver the scanned data of the HS chart as it is to the color adjustment information generation unit 303 without performing paper white calibration. Alternatively, it may also be possible to determine in advance a threshold value th2 separate from the threshold value th1 (th2>th1) and perform notification processing, such as displaying an error or warning, in a case where the absolute value of the difference between W and W0 is larger than the threshold value th2. By doing so, in a case where printing is performed erroneously in the paper white area, which should be the non-print area, or in a case where there is sticking dust, it is possible for a user to grasp the fact, and therefore, improvement of convenience can be expected.

### Third Embodiment

In the second embodiment, the aspect is explained in which the paper white information (paper white average value W0) on the SS chart is stored in advance and the paper white calibration processing is performed by combining the paper white information with the paper white average value W calculated from the HS chart. Incidentally, depending on the configuration of the scan unit 108, there is a case where unevenness resulting from the scan unit 108 occurs in the paper white area, which is the non-print area, even by performing the shading processing using the white reflection standard, which is performed within the scan unit 108. In this case, it is preferable to perform the paper white calibration processing for each sensor position. Consequently, an aspect is explained as a third embodiment in which the sensor value in the direction of the sheet long side in the paper white area is normalized so as to become a predetermined value by performing the above-described paper white calibration processing for each sensor position.

### <Details of Image Processing Unit>

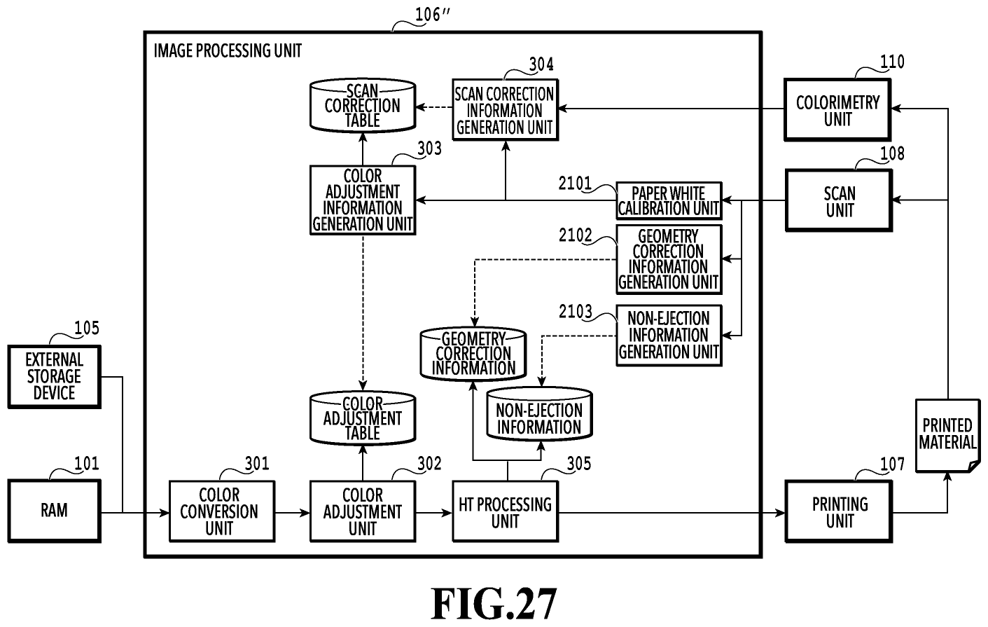

FIG. 27 is a diagram showing the internal configuration of an image processing unit 106″ according to the present embodiment. A paper white calibration unit 2101′ of the present embodiment performs paper white calibration processing of each sensor position, to be described later, for both the scanned data of the HS chart and the scanned data of the SS chart. The scan correction information generation unit 304 in the present embodiment generates a scan correction table based on the scanned data for which the paper white calibration processing of each sensor position in the paper white calibration unit 2101′ has been performed.

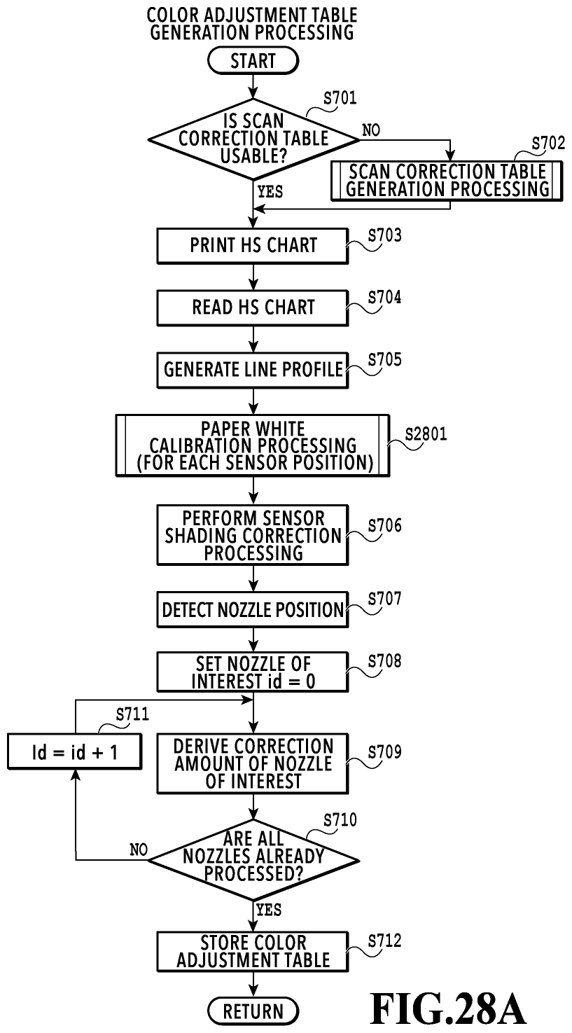

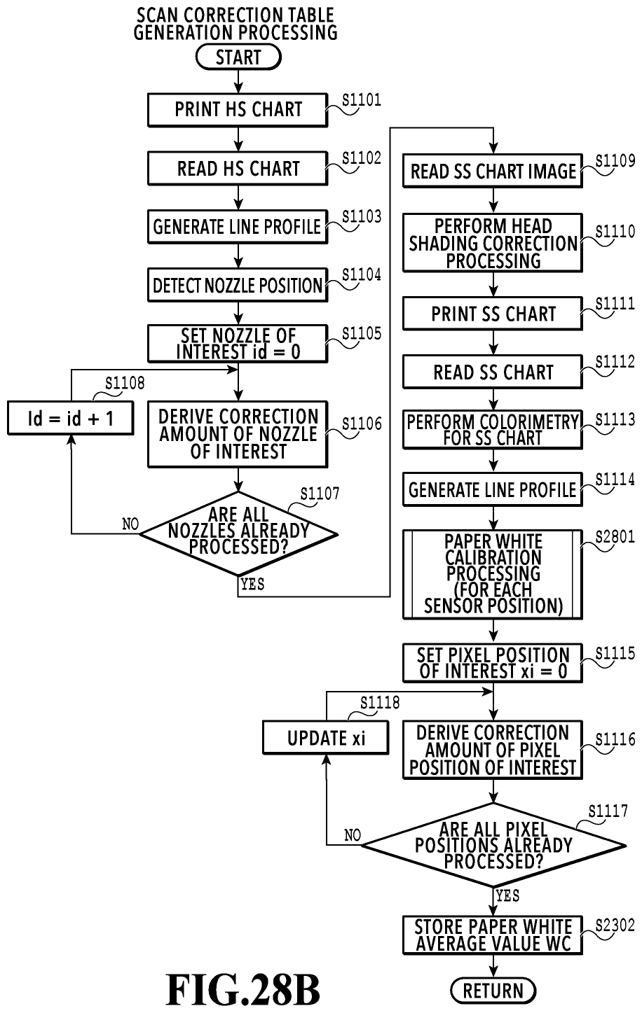

The flowchart shown in FIG. 28A is a diagram showing a flow of the color adjustment table generation processing (S603) according to the present embodiment and the flowchart shown in FIG. 28B is a diagram showing a flow of the scan correction table generation processing (S702) according to the present embodiment. For the color adjustment table generation processing, the flowchart in FIG. 28A differs from that of the first embodiment in that paper white calibration processing of each sensor position (S2801) is inserted between S705 and S706 and for the scan correction table generation processing, the difference is that the paper white calibration processing for each sensor position (S2801) is inserted between S1114 and S1115. In the low in FIG. 28B, different from the flow in FIG. 22 of the first embodiment, paper white calibration processing is performed after the generation of line profile (S1114). The reason is to calibrate the line profile other than the paper white portion for each sensor position by utilizing the line profile of the paper white portion.

### <Paper White Calibration Processing of Each Sensor Position>

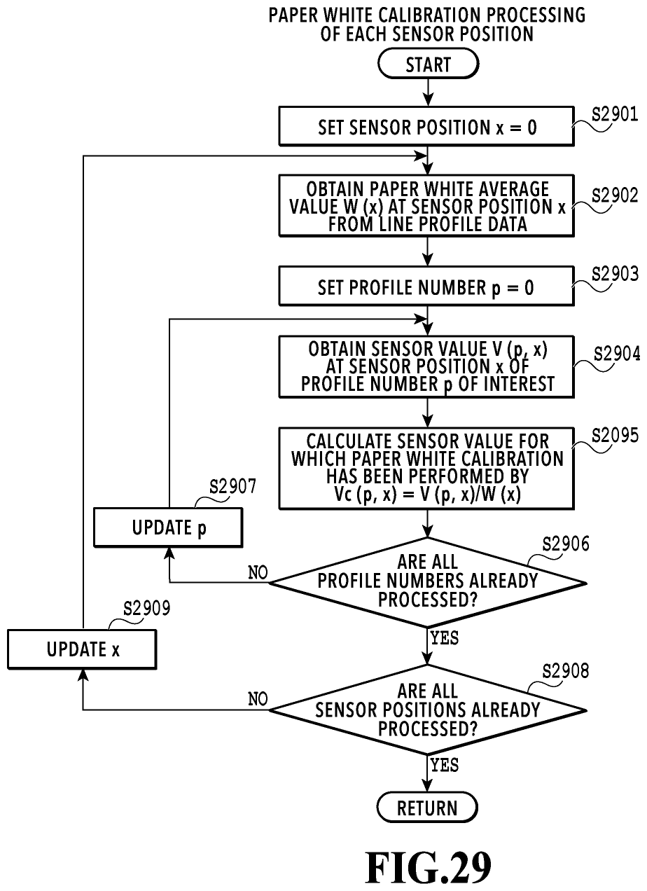

With reference to the flowchart shown in FIG. 29, the paper white calibration processing of each sensor position is explained.

At S2901, the pixel position (sensor position) x in the direction of the sensor is initialized, to which attention is paid as the processing target. Specifically, the sensor position x=0 is set.

At S2902, a paper white average value W (x) at the sensor position x is obtained from the line profile data. That is, in a case of execution within the color adjustment table generation processing, with reference to the line profile data obtained by the generation of line profile at S705, from the line profile corresponding to the measurement area 801, the sensor value corresponding to the sensor position x is obtained. Further, in a case of execution within the scan correction table generation processing, with reference to the line profile data obtained by the generation of line profile at S1114, from the line profile corresponding to the measurement area 801, the sensor value corresponding to the sensor position x is obtained. It may also be possible to obtain the paper white average value W from the margin area of a sheet.

At 52903, a profile number p to which attention is paid as the processing target is initialized. Specifically, the profile number p=0 is set. Here, the profile number is one of sequential numbers for line profiles. For example, in the HS chart shown in FIG. 8, the line profiles are numbered in such a manner that the number of the line profile corresponding to the measurement area 801 is set to “0”, the number of the line profile corresponding to the measurement area 802 under the measurement area 801 is set to “1”, the number of the line profile corresponding to the measurement area 803 under the measurement area 802 is set to “2”, and so on.

At S2904, a sensor value V (p, x) at the sensor position x of the profile number p of interest is obtained.

At S2905, a sensor value Vc (p, x), for which the paper white calibration has been performed, at the sensor position x of the profile number p of interest is calculated. The sensor value Vc (p, x) for which the paper white calibration has been performed is expressed by formula (1) below.

Vc(p,x)=V(p,x)/W(x) formula (1)

At S2906, whether all the profile numbers are already processed as the profile number of interest is determined. In a case where the sensor values Vc (p, x), for which the paper white calibration has been performed, at the sensor position x of all the profile numbers p are already calculated, the processing advances to S2908. On the other hand, in a case where the profile number p that is not processed yet exists, the processing advances to S2907 and the profile number p of interest is updated, and the processing returns to S2904 and the same processing is repeated.

At S2908, whether the processing is already completed for all the sensor positions x is determined. In a case where the processing is already completed for all the sensor positions x, this processing is exited. On the other hand, in a case where the sensor position x that is not processed yet exists, the processing advances to S2909 and the sensor position x is updated, and the processing returns to S2902 and the same processing is repeated.

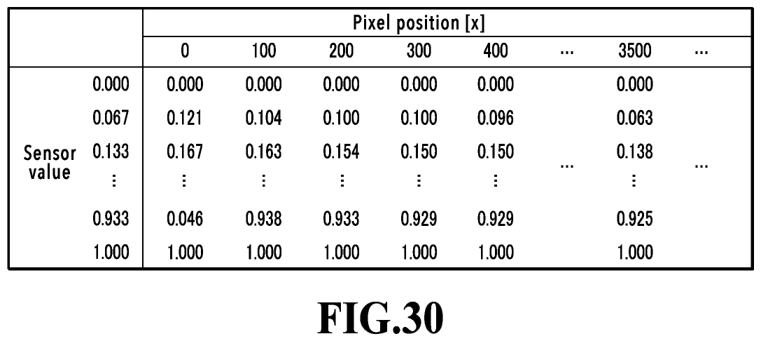

The above is the contents of the paper white calibration processing of each sensor position. FIG. 30 is one example of the scan correction table that is generated in the present embodiment. As shown in FIG. 30, in the scan correction table that is obtained by the method of the present embodiment, corrected sensor values for the sensor values normalized so that the sensor value for the paper white area is “1.0” are stored.

### Effects of the Present Embodiment

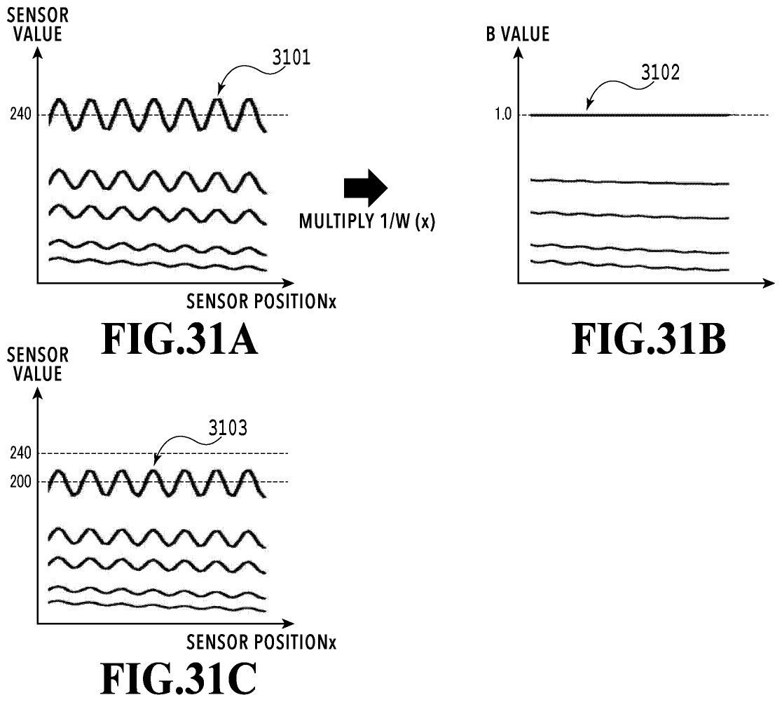

The effects of the present embodiment are explained by using a specific example. FIG. 31A is a diagram schematically showing the line profile at the time of the generation of the table. In FIG. 31A, a wavy curve 3101 is the line profile corresponding to the paper white area (for example, the measurement area 1201 of the SS chart described above). Here, generally, it is preferable that there be no density variations in the paper white area of the sheet that is used for head shading correction. Further, it is preferable that there be no large variations in the line profile 3101 by the shading processing with the white reflection standard, which is performed within the scan unit 208. However, for example, because of the illumination unevenness due to the balance between the two light sources 1085/1086 (see FIG. 26 described previously) or the difference in the distance to the sensor between the white reflection standard and the sheet, the variations of each sensor position as shown in FIG. 31A may occur in the sensor values of the paper white area. Further, it is already known that the illumination unevenness due to the balance between the light sources also occurs as unevenness in accordance with the reflectance thereof also in the measurement area other than the paper white area. In the case such as this, by performing the above-described paper white calibration processing of each sensor position, it is possible to reduce the influence of the illumination unevenness included in each measurement area.

FIG. 31B is a diagram schematically indicating the results of performing the paper white calibration processing of each sensor position for the line profile in FIG. 31A. The paper white calibration is performed for each sensor position for each profile corresponding to the area other than the paper white area by taking the line profile corresponding to the paper white area as the reference. Because of this, for a line profile 3102 of the paper white area in FIG. 31B, the sensor value is “1.0” irrespective of the sensor position x. In the present embodiment, based on the line profile for which the paper white calibration of each sensor position has been performed, the scan correction table illustrated in FIG. 30 is generated.

FIG. 31C is a diagram showing one example of the line profile that is obtained at the time of the application of the table (that is, in a case where the sheet whose characteristics are different from those of the sheet at the time of the generation of the table is used). In FIG. 31C, a wavy curve 3103 is the line profile of the paper white area. Compared to the line profile 3101 at the time of the generation of the table, which is shown in FIG. 31A, although the average value is small, the same illumination unevenness as that at the time of the generation of the table occurs. However, the way the illumination unevenness occurs is not necessarily the same between the curve 3101 and the curve 3103 due to the surface gloss and thickness of the sheet, the mechanical errors and the like. At this time, even though the paper white calibration processing explained in the second embodiment is performed, there is a possibility that the LUT corresponding to the signal value different locally is referred to. Consequently, in the present embodiment, the paper white calibration processing is also performed for each sensor position at the time of the application of the table. Due to this, as the processed line profile, the line profile substantially the same as that in FIG. 31B described above is obtained.

As above, in the present embodiment, the paper white calibration processing of each sensor position is performed so that the sensor value of the paper white area is “1.0” irrespective of the sheet and the sensor position. By doing so, it is possible to suppress the correction error particularly in the bright portion even in a case where the sensor value of the paper white area at the time of the generation of the scan correction table is different from that at the time of the application of the scan correction table. Further, it is also possible to suppress the correction error even in a case where there is illumination unevenness depending on the sensor position in the paper white area and further, the way the unevenness appears at the time of the generation of the table is different from that at the time of the application of the table.

In the example of the internal configuration shown in FIG. 21 and FIG. 27, explanation is given on the assumption that the geometry correction information generation unit 2102 and the non-ejection information generation unit 2103 generate information based on the scanned data input from the scan unit 108. For the detection of general geometry correction information and non-ejection nozzle information, in many cases, a line pattern or marker formed solid is used. Then, in the detection such as this, in many cases, a sufficiently large difference is obtained for color unevenness and illumination unevenness that cause a problem in the above-described color adjustment information. Because of this, there is a case where it is made possible to detect a pattern or generate color adjustment information by simple binarization processing. In the case such as that, it may also be possible to lighten the processing load by not performing the paper white calibration processing or the color adjustment processing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the technique of the present disclosure, it is possible to suppress a reduction in accuracy at the time of color adjustment.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2022-154801, filed Sep. 28, 2022, and No. 2023-137187, filed Aug. 25, 2023, which are hereby incorporated by reference herein in their entirety.

What is claimed is:

1. An image forming apparatus comprising:
a printing unit configured to perform print processing based on image data;
an image processing unit configured to perform color adjustment processing for the image data by using color adjustment information in accordance with characteristics of the printing unit;
a first generation unit configured to generate the color adjustment information based on scanned data obtained by reading a first chart output from the printing unit by a scan unit; and
a second generation unit configured to generate scan correction information in accordance with reading characteristics of the scan unit based on colorimetric data obtained by measuring a second chart output from the printing unit by a colorimetry unit, wherein
the image processing unit performs the color adjustment processing for image data of the second chart before the printing unit prints and outputs the second chart, which is a target of the measurement, in a case where the second generation unit generates the scan correction information.

2. The image forming apparatus according to claim 1, wherein
resolution of the scanned data obtained by the scan unit is different from resolution of the colorimetric data obtained by the colorimetry unit and
the second generation unit generates the scan correction information by performing processing to match the resolution of the scanned data with the resolution of the colorimetric data.

3. The image forming apparatus according to claim 1, wherein
the first generation unit corrects the scanned data of the first chart, which is obtained by the scan unit, by using the scan correction information and generates the color adjustment information by using the corrected scanned data.

4. The image forming apparatus according to claim 1, wherein
in a case where a print job is input:
the image processing unit performs the color adjustment processing for image data based on the print job; and
the printing unit performs the print processing by using the image data for which the color adjustment processing has been performed.

5. The image forming apparatus according to claim 1, wherein
the color adjustment processing for the image data of the second chart is processing aiming at removal of density unevenness whose frequency is higher than or equal to a specific frequency.

6. The image forming apparatus according to claim 5, wherein
the density unevenness whose frequency is higher than or equal to the specific frequency is density unevenness whose frequency corresponds to the diameter or less of an opening of the colorimetry unit.

7. The image forming apparatus according to claim 1, wherein
the colorimetry unit obtains a device-independent colorimetric value based on spectral reflectance on an image formed in the second chart.

8. The image forming apparatus according to claim 7, wherein
the device-independent colorimetric value is a value in accordance with CIE Lab.

9. The image forming apparatus according to claim 1, wherein
the printing unit performs the print processing by conveying a sheet in one direction and ejecting ink droplets by a print head that covers the entire width of the conveyed sheet.

10. The image forming apparatus according to claim 9, wherein
the colorimetry unit includes a plurality of colorimeters arranged in a direction perpendicular to the conveyance direction.

11. The image forming apparatus according to claim 9, wherein
the colorimetry unit includes a single colorimeter that performs a scan in a direction perpendicular to the conveyance direction.

12. The image forming apparatus according to claim 3, wherein
the correction that is performed by the first generation unit is processing to suppress variations of the reading characteristics of the scan unit based on a colorimetric value included in the colorimetric data at a position corresponding to the first chart and a sensor value included in the scanned data.

13. The image forming apparatus according to claim 12, wherein
in the correction that is performed by the first generation unit, by performing function approximation for at least one of a colorimetric value included in the colorimetric data and a sensor value included in the scanned data, the colorimetric value at the corresponding position and the sensor value are obtained.

14. The image forming apparatus according to claim 9, wherein
printing processing of the first chart is performed using a yellow ink.

15. The image forming apparatus according to claim 9, wherein
a conveyance unit configured to convey a sheet to the printing unit, the scan unit, and the colorimetry unit is a common unit.

16. The image forming apparatus according to claim 9, wherein
a conveyance unit configured to convey a sheet to the printing unit and the scan unit is different from a conveyance unit configured to convey a sheet to the colorimetry unit.

17. The image forming apparatus according to claim 3, further comprising:
a user interface unit configured to present available colorimetry units and cause a user to select a colorimetry unit that is used for measurement of the second chart.

18. The image forming apparatus according to claim 1, wherein
the first generation unit:
performs calibration processing to match a sensor value in a predetermined area of the scanned data of the first chart with a sensor value in the predetermined area in a case where the scan correction information is generated; and
generates the color adjustment information based on the scanned data of the first chart, for which the calibration processing has been performed.

19. The image forming apparatus according to claim 18, wherein
the predetermined area is an area corresponding to paper white of a sheet.

20. The image forming apparatus according to claim 19, wherein
the calibration processing is processing to match a sensor value in an area corresponding to the paper white of the sheet of the scanned data of the first chart with a sensor value in an area corresponding to the paper white of the sheet in a case where the scan correction information is generated.

21. The image forming apparatus according to claim 18, wherein
the first generation unit performs the calibration processing in a case where characteristics of a sheet relating to printing and outputting for generating the color adjustment information and characteristics of a sheet relating to printing and outputting for generating the scan correction information are different.

22. The image forming apparatus according to claim 21, wherein
the case where characteristics of a sheet are different is a case where the type of sheet is different.

23. The image forming apparatus according to claim 21, wherein
the case where characteristics of a sheet are different is a case where a specific component is present within one sheet and not present within the other.

24. The image forming apparatus according to claim 18, wherein
the scan unit is a line sensor that covers the entire width of the sheet and
the first generation unit performs the calibration processing for each reading position of the line sensor.

25. The image forming apparatus according to claim 23, wherein
the first chart has a plurality of areas whose densities are different from one another and
the first generation unit:
finds a plurality of line profiles corresponding to each of the plurality of areas from the scanned data of the first chart, which is obtained by the scan unit; and
performs the calibration processing for each reading position of the line sensor based on the plurality of line profiles.

26. The image forming apparatus according to claim 19, wherein
the first generation unit does not perform the calibration processing for the scanned data of the first chart in a case where a difference between a sensor value average in an area corresponding to the paper white of the sheet of the scanned data of the first chart and a sensor value average in an area corresponding to the paper white of the sheet in a case where the scan correction information is generated is smaller than a threshold value.

27. The image forming apparatus according to claim 19, wherein
the first generation unit performs predetermined processing in a case where a difference between a sensor value average in an area corresponding to the paper white of the sheet of the scanned data of the first chart and a sensor value average in an area corresponding to the paper white of the sheet in a case where the scan correction information is generated is larger than a threshold value.

28. A control method of an image forming apparatus comprising:
performing color adjustment processing for image data by using color adjustment information in accordance with characteristics of a printing unit configured to perform print processing based on the image data;
generating the color adjustment information based on scanned data obtained by reading a first chart output from the printing unit by a scan unit; and
generating scan correction information in accordance with reading characteristics of the scan unit based on colorimetric data obtained by measuring a second chart output from the printing unit by a colorimetry unit, wherein
in a case where the scan correction information is generated, the color adjustment processing is performed for image data of the second chart before the printing unit prints and outputs the second chart, which is a target of the measurement.

29. A non-transitory computer readable storage medium storing a program for causing a computer to perform a control method of an image forming apparatus comprising:
performing color adjustment processing for image data by using color adjustment information in accordance with characteristics of a printing unit configured to perform print processing based on the image data;
generating the color adjustment information based on scanned data obtained by reading a first chart output from the printing unit by a scan unit; and
generating scan correction information in accordance with reading characteristics of the scan unit based on colorimetric data obtained by measuring a second chart output from the printing unit by a colorimetry unit, wherein
in a case where the scan correction information is generated, the color adjustment processing is performed for image data of the second chart before the printing unit prints and outputs the second chart, which is a target of the measurement.
